(19) United States
(12) Patent Application Publication
(10) Pub. No.: US 2025/0135606 A1
(43) Pub. Date: May 1, 2025

(54) MECHANICAL CLAMP WITH COMPRESSIBLE LINK

(71) Applicant: Machina Labs, Inc., Chatsworth, CA (US)

(72) Inventor: Kyle Hickey, Moorpark, CA (US)

(21) Appl. No.: 18/931,486

(22) Filed: Oct. 30, 2024

Related U.S. Application Data
(60) Provisional application No. 63/594,922, filed on Oct. 31, 2023.

(51) Int. Cl. B25B 5/00

(52) U.S. Cl. CPC B25B 5/003

(57) ABSTRACT

A mechanical clamp may include an actuator having an end that is movable. The mechanical clamp may include a base link with a first link end configured to be movably coupled to a link pivot point and with a second link end movably coupled to the end of the actuator. The mechanical clamp may include a clamp arm including: a clamp interface, a first arm coupling element, and a second arm coupling element mounted to a clamp pivot point, where the first arm coupling element and the clamp interface are configured to rotate about the clamp pivot point. The mechanical clamp may include a compressible link the couples the second link end with the first arm coupling element, where rotation of the second link end about the link pivot point causes the compressible link to exert force against the first arm coupling element.

### CROSS-REFERENCE TO RELATED APPLICATION

This application claims the benefit of, and priority to, U.S. Provisional Patent Application Ser. No. 63/594,922, “Sheet Part Forming Components and Methods,” filed Oct. 31, 2023, which is incorporated herein by reference in its entirety.

### BACKGROUND

### Technical Field

This disclosure relates generally to mechanical clamps for holding objects.

### Description of Related Art

Clamping systems can apply mechanical force to hold objects in place during manufacturing or assembly operations.

### BRIEF DESCRIPTION OF THE DRAWINGS

Embodiments of the disclosure have other advantages and features which will be more readily apparent from the following detailed description and the appended claims, when taken in conjunction with the examples in the accompanying drawings, in which:

FIG. 1 is a perspective view of a robotic setup for part forming, according to an embodiment.

FIG. 2A is block diagram of a model, according to an embodiment.

FIG. 2B is a block diagram of a part forming process, according to an embodiment.

FIG. 3 is an image from a simulated part forming process, according to an embodiment.

FIG. 4 is a perspective view of a robotic setup with optical trackers, according to an embodiment.

FIG. 5A is a perspective view of a robot arm with a scanner and load sensor, according to an embodiment.

FIG. 5B is an image generated using scanner data, according to an embodiment.

FIG. 6 includes plots of different forming paths to form a cone, according to an embodiment.

FIGS. 7A-7D illustrate a forming process, according to an embodiment.

FIGS. 8A-8B are perspective views of first and second roller tools, according to some embodiments.

FIG. 9 is a perspective view of a frame holding a sheet, according to an embodiment.

FIG. 10A is a perspective view of a robot arm with a stylus performing a forming operation, according to an embodiment.

FIG. 10B is a perspective view of a robot arm with a trimming performing a trimming operation, according to an embodiment.

FIG. 10C is a perspective view of a robot arm with a hemming performing a hemming operation, according to an embodiment.

FIG. 10D is a perspective view of a tool rack holding a plurality of tools, according to an embodiment.

FIG. 11 is a perspective of a third roller tool, according to an embodiment.

FIG. 12 is a perspective of fourth roller tool, according to an embodiment.

FIG. 13 includes images of two different parts made using a same part design and different forming techniques, according to an embodiment.

FIGS. 14A-14B are block diagrams of other models, according to some embodiments.

FIG. 15 is a block diagram illustrating components of an example machine able to read instructions from a machine-readable medium and execute them in a processor, according to an embodiment.

FIGS. 16A-16K are diagrams of a mechanical clamp, according to an embodiment.

FIG. 17 is a diagram of multiple clamps, according to an embodiment.

FIG. 18 is a diagram of an arrangement of clamps on a frame, according to an embodiment.

FIG. 19 is a diagram of another mechanical clamp, according to an embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

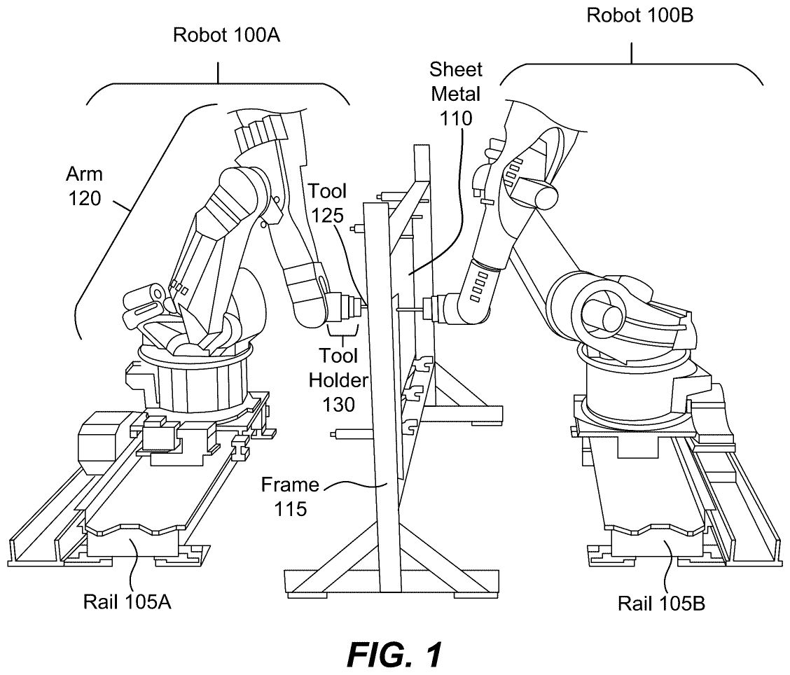

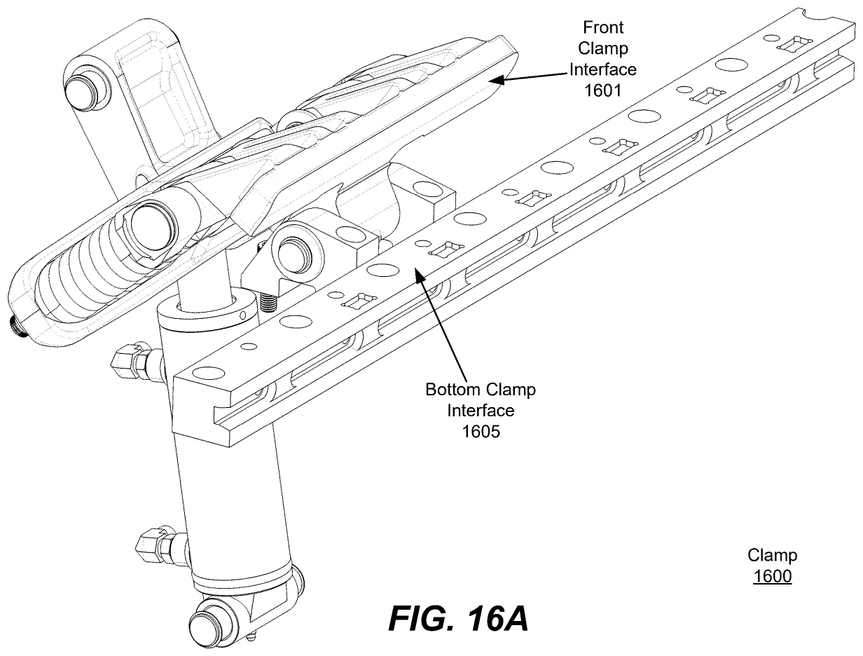

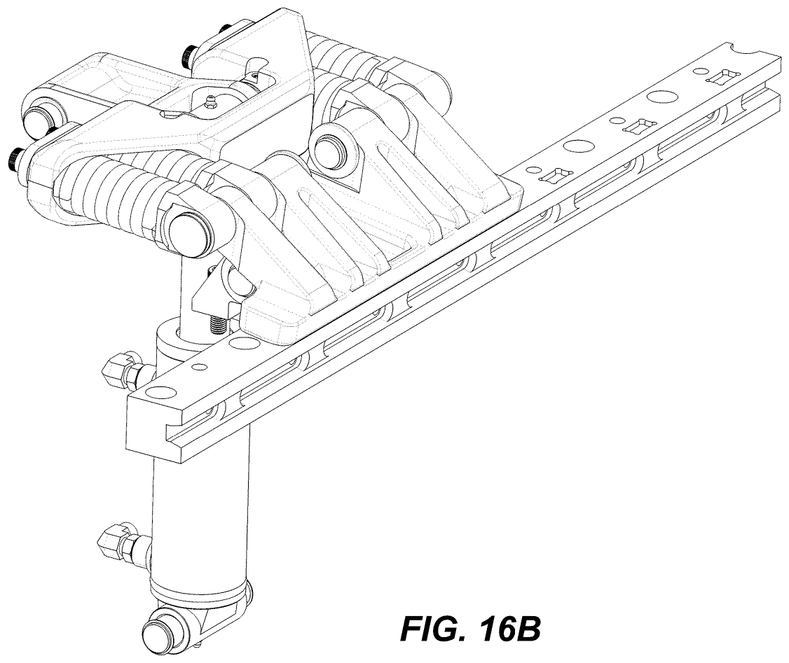

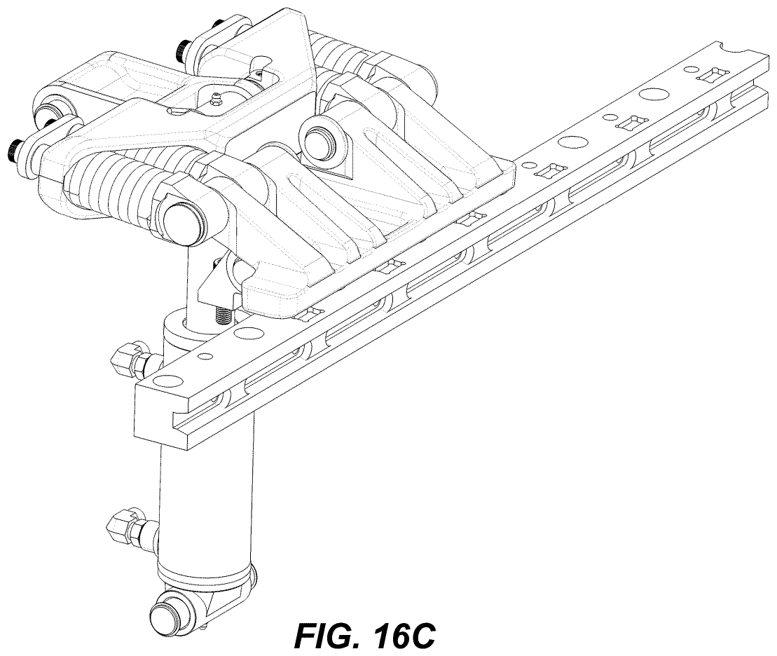

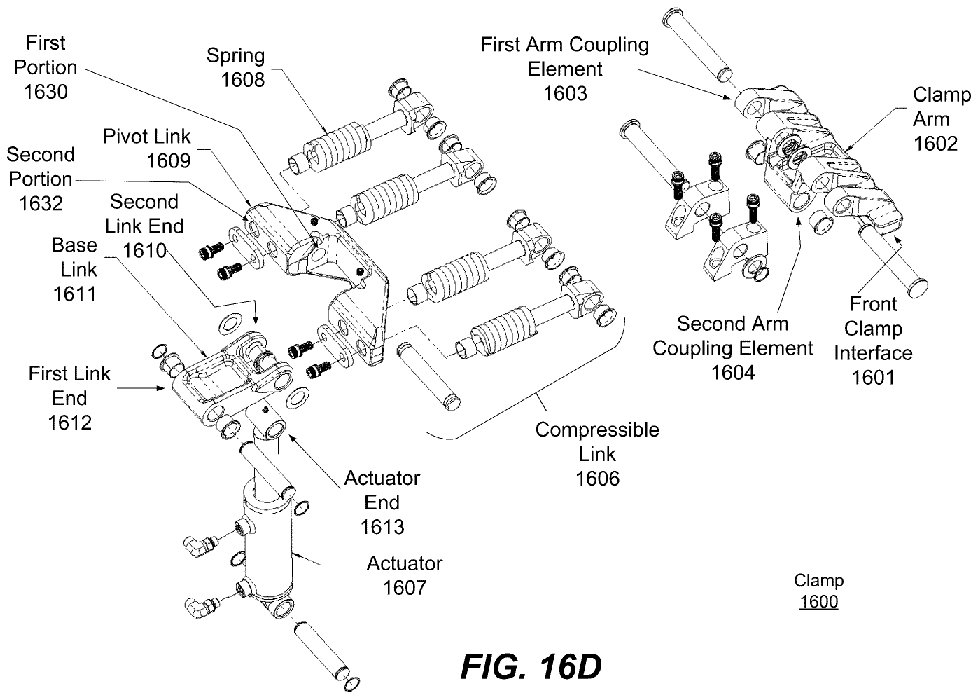

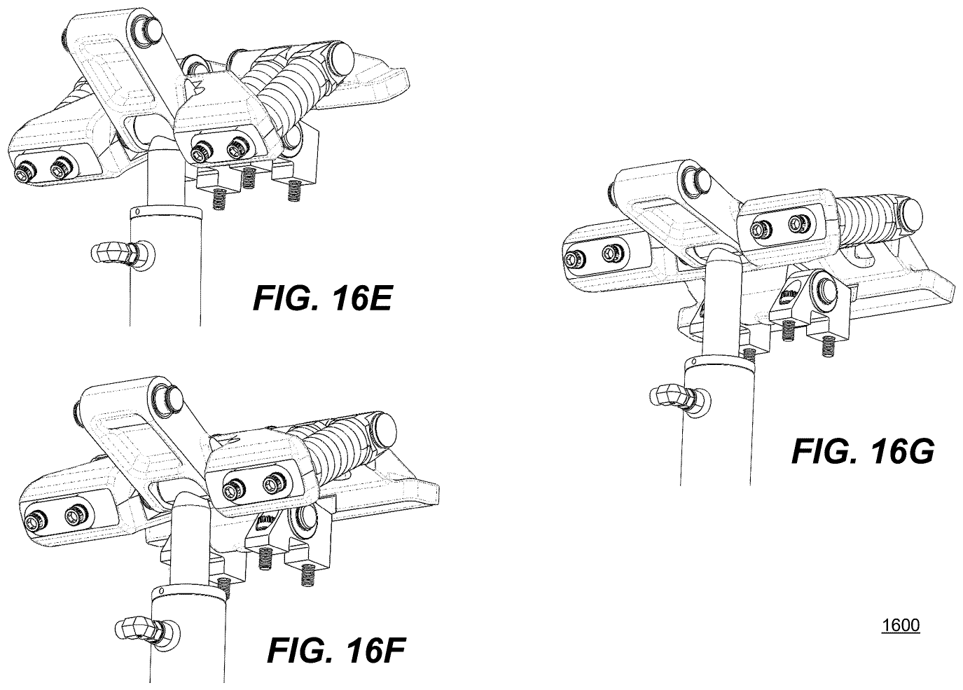

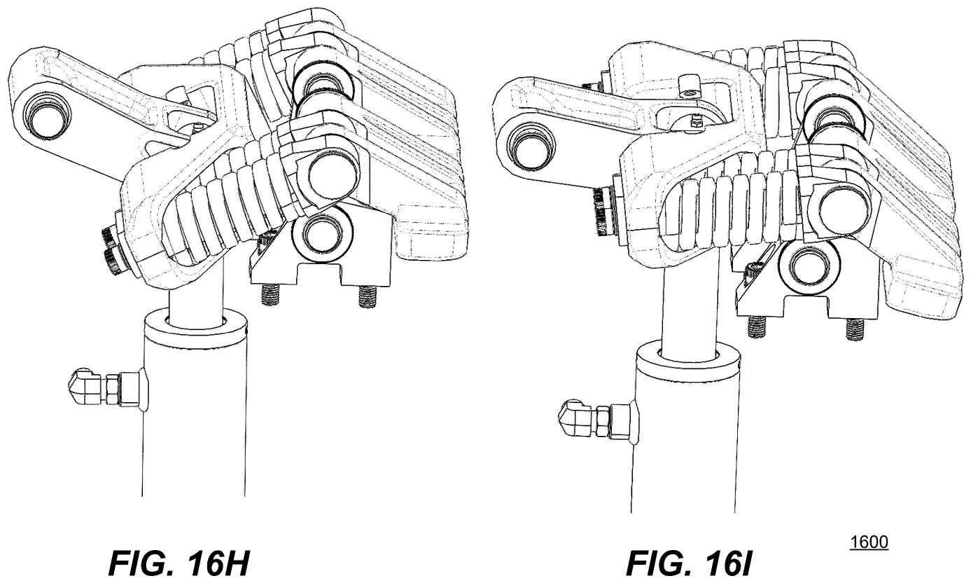

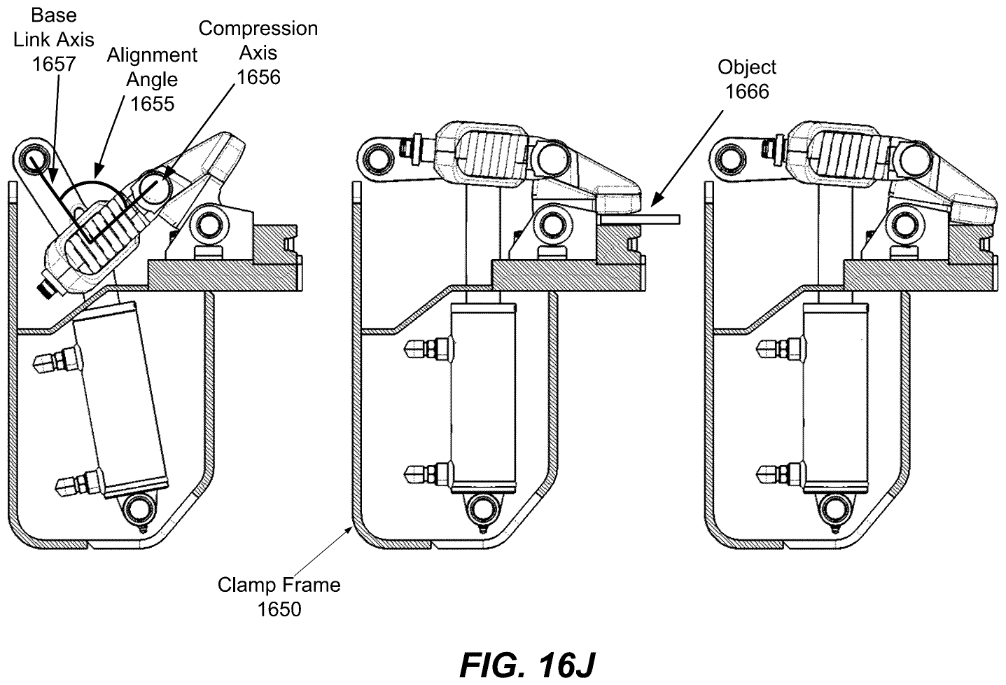

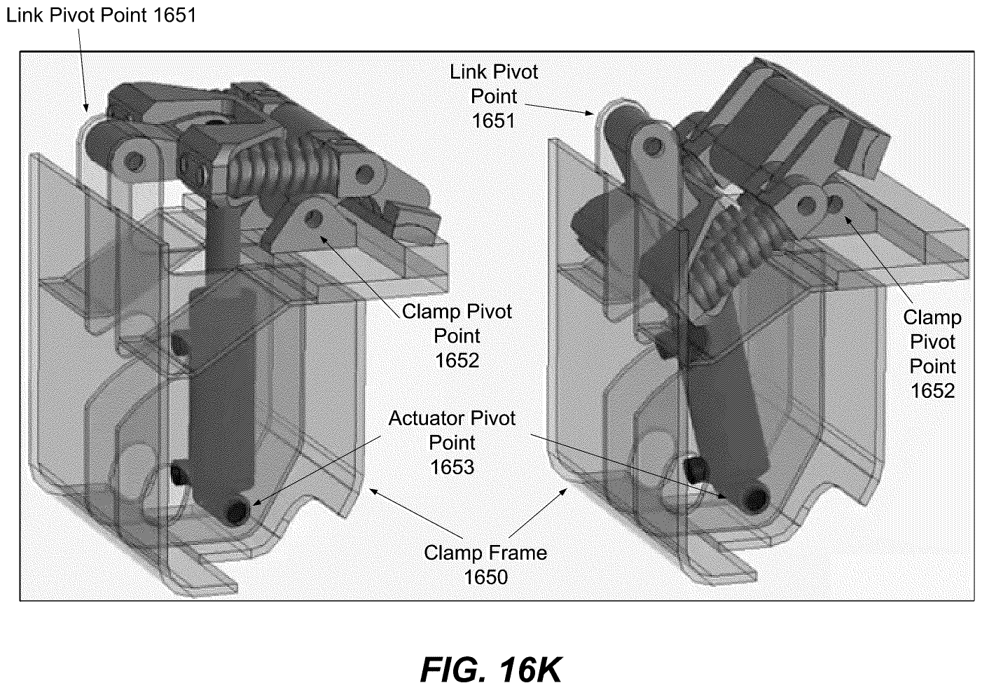

Some embodiments relate to mechanical clamps or clamping systems, which are described in part below with respect to FIGS. 16A-19. These clamps and clamping systems may be part of a system for robotic sheet forming, which is described (in part) with respect to FIGS. 1-15.

In a first embodiment a mechanical clamp is configured to hold an object, the mechanical clamp including: an actuator having an end that is movable; a base link with a first link end configured to be movably coupled to a link pivot point and with a second link end movably coupled to the end of the actuator, movement of the end of the actuator to cause the second link end to rotate about the link pivot point; a clamp arm including: a clamp interface configured to interface with a surface of the object to be held; a first arm coupling element; and a second arm coupling element mounted to a clamp pivot point, the first arm coupling element and the clamp interface configured to rotate about the clamp pivot point; and a compressible link with a spring configured to compress along a compression axis, the compressible link coupling the second link end with the first arm coupling element, rotation of the second link end about the link pivot point to cause the compressible link to exert force against the first arm coupling element.

In a second embodiment a clamping system includes: a set of two or more mechanical clamps, at least one mechanical clamp of the set including: an actuator having an end that is movable; a base link with a first link end coupled to a link pivot point and a second link end coupled to the end of the actuator, movement of the end of the actuator causing the second link end to rotate about the link pivot point; a clamp arm including: a clamp interface configured to interface with an object to be held; a first arm coupling element; and a second arm coupling element mounted to a clamp pivot point, the first arm coupling element and the clamp interface configured to rotate about the clamp pivot point; and a compressible link configured to compress along a compression axis, the compressible link coupling the second link end with the first arm coupling element, rotation of the second link end about the link pivot point causing the compressible link to exert force against the first arm coupling element; and a control system configured to control the set of clamps.

### 1. Robotic Sheet Metal Part Forming

Robotic sheet part forming is a sheet metal part forming technique where a sheet is formed into a desired geometry by a series of incremental deformations applied by a robot. For example, the robot is outfitted with a stiff stylus that delivers deformations to the sheet. The robot may change tools to apply different operations (e.g., trimming and hemming) to the metal part. Multiple robots may be used in the process to provide more accurate control of the process.

Increasing the speed and decreasing the cost to manufacture sheet metal parts is desirable for enhancing product development in all stages of design and manufacturing. In light of this, some embodiments relate to an intelligent machine learning-based system that automates object process parameter generation for real-time control of novel robotic forming of sheet metal, plastics, polymers, and composite parts. Relative to conventional techniques, the disclosed (e.g., fast forming) techniques may enable faster prototyping and may enable rapid customization of mass-produced products. Agile production or prototyping in turn enables development of better-quality products and streamlining production. It may also increase industrial competitiveness in both mature and emerging markets by reducing the time and capital used for developing new components. The benefits may extend further for “lightweighting” strategies employed in various industries (e.g., aerospace and automotive) that want to move towards lighter and higher strength alloys but are slowed down by testing of these alloys. For simplicity, the below descriptions refer to forming parts from sheet metal. However, as indicated above, embodiments described herein may be applicable to forming parts from other materials, such as plastics, polymers, and composites.

Robotic sheet metal part forming overcomes the restrictions of the traditional methods by reducing or removing fabrication of tooling and dies from the production process. Robotic sheet part forming is a sheet metal part forming technique where a sheet is formed into a desired geometry by a series of (e.g. small) incremental deformations applied by a robot. For example, the robot is outfitted with a stiff stylus that delivers deformations to the sheet. Multiple robots may be used in the process to provide more accurate control of the deformations.

FIG. 1 illustrates an example embodiment of a setup for robotic sheet metal part forming. Two robots 100A and 100B face each other on respective rails 105A and 105B on opposite sides of the sheet metal 110. The sheet metal is supported by a frame 115 (also referred to as a fixture). Specifically, edges of the sheet metal are coupled (e.g., clamped) to the frame to hold the sheet metal in place. The sheet metal is fixed between the two robots to allow easy access from both robots to opposite sides of the sheet. The robots may be high payload industrial robotic arms that can exert forces sufficient to deform the sheet metal (e.g., up to 20,000 N). The amount of force exerted may depend on the material strength and thickness of the sheet. For example, for 2 mm 5xxx aluminum (including aluminum alloys), the peak forces may be 2,000N. In another example, for high strength martensitic steel, the peak forces may be 20,000N. The amount of force may also depend on process parameters. For example, there may be a tradeoff between time duration and force (e.g., a 1 mm stainless steel part takes 4 hours to form with a peak force of 4,000N but it takes 8 hours to form if the peak force is 3,000N). The robots may comprise an articulated 6-axis robotic arm (e.g., arm 120) capable of moving a tool (e.g., tool 125) (also referred to as an end effector) attached to the end of the arm in a three-dimensional space according to 6 degree of freedom motion. The arm may include an actuator system configured to move the robot in space. For example, each segment of the robot arm includes an actuator to move it relative to another arm segment. The end of the robot arm includes a tool holder (e.g., tool holder 130) that enables one or more selectable types of tools to be attached. The tools can include, for example, a hard stylus having ends of varying diameters, shapes, or materials, a roller tool as described below, a spindle tool, a laser tool, a plasma torch, a cutting tool, or a hole making tool. The robots are also slidable along the rails to enable the robots to operate over a wide range of sheet metal sizes and sizes of the part being fabricated. For example, the part can be as small as a few cubic inches or as big as a few cubic feet (in the volume it occupies). The robot's arms may be controlled by a controller (e.g., an external computation system) that takes into account the geometry of the final part and signals from one or more various sensors installed on the robot. The sensors may include, for example, accelerometers, gyroscopes, pressure sensors, or other sensors for detecting motion, position, and interactions of the robot with the sheet metal.

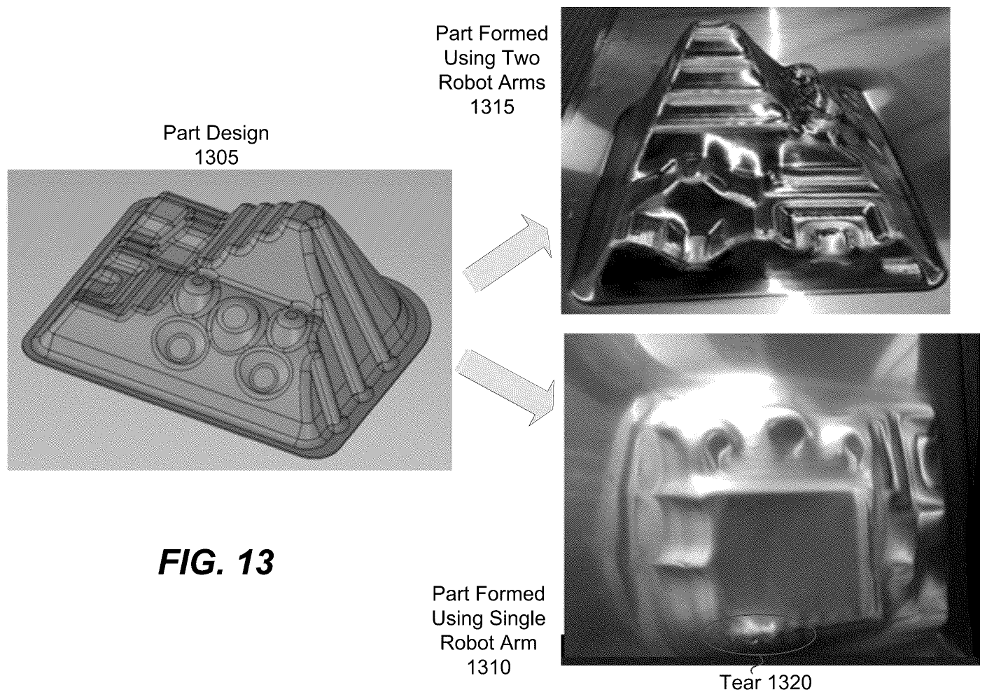

The use of two robots (one on each side of the sheet) may provide several advantages. For example, if only a single robot is used, the sheet may globally deform (instead of locally deform). Thus, using two robots may enable localized deformations. A second robot (also referred to as a support robot) may reduce or prevent tearing of the part by providing supporting pressure on the opposite side of the part. The location of the robots (and their end effectors) with respect to each other may be based on the design of the part and the material and thickness of the sheet. These locations may be determined by a model (described further below). An example of the advantages of two robots is illustrated in FIG. 13. FIG. 13 includes a part design 1305 that illustrates the design of a part to be formed. The images on the right illustrate parts formed based on the design 1305. The bottom right image illustrates a part 1310 formed using only one robot and the top right image illustrates a part 1315 formed using two robots. As illustrated, part 1315 includes more details and more closely resembles the part in 1305. Additionally, the part 1301 includes a tear 1320.

A controller may receive and process sensor data from the sensors to determine the proper parameters (e.g., joint angle values for each joint of the robotic arm) and control the robot arms accordingly. In some embodiments, the robots are controlled to pinch or otherwise apply pressure to the sheet metal with a hard implement (e.g., a stylus) or other tool to form the sheet of metal in accordance with a program applied by the controller to result in a desired geometry. For example, the program controls the robot arms to move in a particular sequence and apply the tool to the sheet metal according to particular programmed parameters at each step (e.g., time step) of the sequence to achieve a programmed geometry. The program (via the robotic arms) may cause the different applied tools to bend, pinch, cut, heat, seam, or otherwise form the metal in accordance with the program.

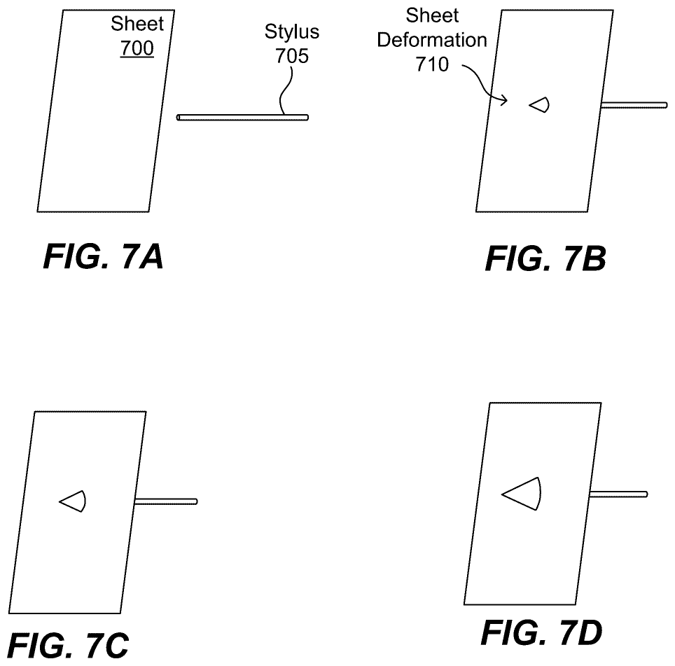

An example part forming process is illustrated in FIGS. 7A-7D. The FIGS. include a sheet 700 and a stylus 705 (e.g., coupled to a robot arm). In FIG. 7B the stylus is applied to the sheet. The result is a deformation 710. FIGS. 7C and 7D illustrate larger deformations that result from the stylus being applied to different locations on the sheet (e.g., in a spiral pattern). To facilitate the deformation into a desired geometry (e.g., a cone), a second tool (e.g., coupled to a second robot arm) may be applied to the opposite surface of the sheet.

### 2. Controller and Model

The controller determines the process parameters to achieve the desired robotic forming operations. Parameters such as the path of the robotic forming tool during the process, its speed, geometry of the forming tool, amount of force, angle and direction of the forming tool, clamping forces of the sheet, etc. may have direct but nonlinear effects on the final geometry. The part forming process may include a set of time steps, where each step describes parameters values for one or more parameters. The part forming process may be iterative. Thus, by executing the system according to the parameter values at each time step, the controller may form the part described in the input design. The parameters values may be determined by the model.

The disclosed robotic system may achieve real-time adaptive control of a part forming process. The method may start with an input design of a part and a (e.g., statistical) model that is generated using a training data set. The training data set may include data from simulation data, and physical process characterization data (such as an in-process inspection or post-build inspection from previously formed parts or geometries). An in-process inspection may include inspecting a part during the forming process. For example, a scanning sensor records the shape of the part as it is being formed. In another example, an eddy current sensor detects defects like cracks. In another example, a force sensor measures the forces applied to the part. A post-build inspection is intended to gather information on a fully formed part. A post-build inspection may include similar inspection techniques as an in-process inspection (e.g., inspecting a part using a scanning sensor or eddy current sensor). However, a post-build inspection may include inspection techniques not performed while the part is being formed (e.g., due to practicality). For example, a fully formed part may be inspected using an x-ray machine.

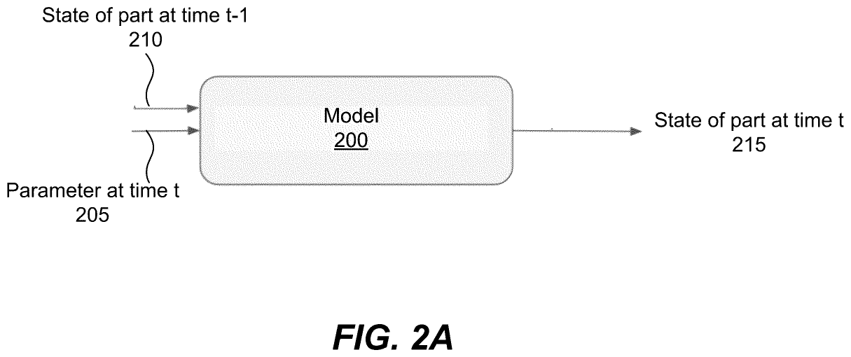

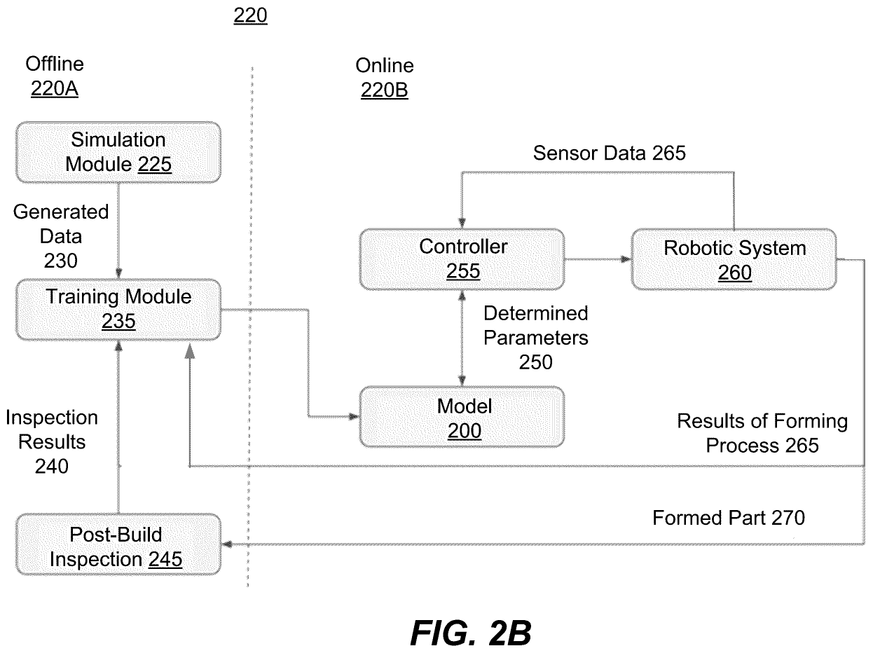

FIG. 2A is a block diagram of an example model 200. As indicated above, the model may be a machine learned statistical model. The model receives one or more parameters 205 to be applied at time step t and the state 210 of the part at time step t−1. The state may refer to the geometry of the part. The model outputs the state 215 of the part at time step t. Thus, for a given state, the model can predict how the part will respond to the application of various parameters. More generally, the model may be used to predict how a material will deform when it goes through a programmed forming process (e.g., over multiple time steps)

A state of the part may be described by a mesh. The mesh may be a graph of coupled nodes, where each node represents a physical point of the part metal. Each node may be described by the following variables: X, Y, Z, F1z, F1x, F1y, F2z, F2x, F2y, thickness, dx, dy, and dz. X, Y, and Z represent the location of the node in space. Thickness indicates the sheet thickness at that node. Each node may be coupled to neighboring nodes (e.g., three neighbors). These coupled nodes represent the part in cartesian space. F1z, F1x, and F1y represent the force that one of the robots (e.g., robot 1) is applying at that node, and F2z, F2x, F2y represent the force another robot (e.g., robot 2) is applying at that node. dx, dy, and dz represent the size of movements capable at a node if the robots pull back from the part at this time (e.g., they capture the elastic strain of the material).

The model can be used to determine the process parameters (e.g., in real time or offline). This method automates the generation of parameters for the robotic forming process (further described in the next paragraph). Due to the optimization process, the generated parameters may not be conceivable by engineers.

After the model is determined (e.g., by a training process), optimization techniques may be used to determine parameters to apply at each (e.g., time) step of the part forming process to create the intended part geometry. For example, for a given time step, the model is applied to various input parameter values according to an optimization technique to determine which parameter values will result in a desired geometry (or a geometry close to the desired geometry). Multiple optimization techniques may be used. Example optimization techniques include gradient descent, Adam optimization, and Bayesian optimization. An optimization technique may be chosen based on the complexity of the desired geometry. The optimization may be done both in the long and short horizons (e.g., time scales). The long horizon optimization may be done offline (before the part forming process begins) to determine steps of the process (e.g., step by step instructions for the robot to achieve the desired geometry). For example, a long horizon optimization may determine how to form a material sheet into a fully formed part. In some embodiments, long horizon optimizations determine a set of intermediate geometries that occur during a part forming process (e.g., intermediate geometries between the sheet and the fully formed part (e.g., for each time step or layer)). However, errors or inaccuracies may accrue over time (e.g., for processes with lengthy build times or processes with a large number of time steps). For example, the part may deform differently than the model predicted. To remedy this issue, short horizon optimizations may be performed during the forming process (online) to reduce or correct errors that may accrue. For example, the model is queried by a (e.g., online) controller that can modify (e.g., correct) steps determined during the long horizon optimization based on the current state of the sheet. For example, for a given time step, instead of assuming the part has a geometry predicted by the long horizon optimization, sensor data may be used to determine the actual geometry of the part. The model may then be queried to determine a new set of parameter values for the time step (or modify the long horizon parameters associated with the time step). For example, the model may be queried to determine which parameter values will form the actual geometry into the predicted geometry (or another intermediate geometry from the long horizon optimization).

While long horizon optimizations may be used to determine an entire part forming process or significant portions of the process, determinations made by short horizon optimizations may be limited to small portions of the part forming process. For example, a short horizon optimization determines a number of interactions (e.g., less than ten) between the end effector and the part. In another example, a short horizon optimization determines interactions between the end effector and the part that will occur during a time window (e.g., less than ten seconds). In another example, a short horizon optimization determines parameter values for a set of time steps (e.g., less than ten time steps). In another example, a short horizon optimization determines how to form a part in a first geometry into a second geometry, where the first and second geometries are intermediate geometries determined by a long horizon optimization. In another example, a short horizon optimization is used to determine how to form a part so that it is a threshold percent closer to a final geometry (e.g., less than ten percent).

In some embodiments, a long horizon optimization is used without short horizon optimizations (e.g., the model has a threshold accuracy or the part forming process has a short build time or a small number of time steps). In some embodiments, short horizon optimizations are used without a long horizon optimization.

Referring back to the model 200, the model may be trained using the data from a simulation module. Additionally, or alternatively, the model 200 may be trained using data (e.g., sensor data) from a physical process that forms a part.

In some embodiments, multiple models are trained. For example, models may be trained using different machine learning techniques. Additionally, or alternatively, models may be trained for specific materials (e.g., steel vs. aluminum), geometries (simple vs. complex), or sheet thickness (e.g., 1 mm vs. 2 mm). Among other advantages, models trained for specific specifications may be more accurate than a general model.

FIG. 2B is a block diagram illustrating an example of the process 220. The process includes an offline learning process 220A and online process 220B. In this context, “online” refers to a time period when a part forming process is occurring (e.g., a robot is deforming a metal sheet to form a part), and “offline” refers to a time before or after a part forming process. The offline process uses simulation data 230, data 265 generated by an in-process inspection, and data 240 generated by a post-build inspection (of the formed part 270) to train model 200. Example data from an in-process inspection is metrology data. Example data post-build inspections includes geometry scans or X-rays of the finished part. After the model 200 is generated, it may be used to determine a part forming process.

The model 200 may also be applied by the controller 255 of the robotic system 260 in the online process. More specifically, the model 200 may determine predictions about the resulting change in geometry from each parameter change at each point in time in the part forming process. In the online process, the controller uses sensors installed on the robotic forming system to obtain sensor data 265 to determine a current geometry of the part. The current geometry may then be input to the model 200. The model predicts the outcome (e.g., a resulting change in geometry) of changes in those process parameters. By iterating over different possible parameters and their outcome predicted by the model, the controller identifies and chooses the (e.g., best) parameter 250 that produces the most desirable outcome to control the robotic forming system through a forming process that achieves the desired geometry. The controller uses the best parameters and may repeats this optimization cycle (e.g., in every step of the process) to improve the outcome.

In addition to the model 200 described above with respect to FIG. 2A, other models are possible. Two examples are provided below.

### 2.1 Blackbox Model

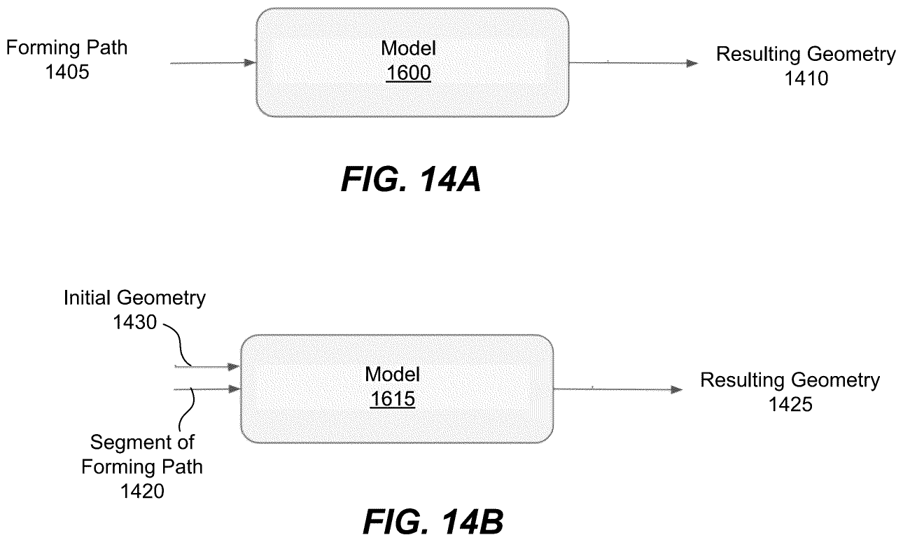

FIG. 14A illustrates an example black box model 1400. The model receives an entire forming path 1405 to be applied to a material sheet and outputs the resulting final geometry 1410 formed by the path. Thus, the model may be trained using data that describes various forming paths and the resulting part geometries. Since the model is not trained to account for physical phenomena (e.g., elastic deformation, global deformation, buckling) the model may be trained using large amounts of training data.

A more complex model is the one that breaks the forming process into layers and tries to predict the effect of various parameter values at each layer. In this context, “layer” refers to a section of a part. For example, a first layer refers to the section that extends one inch away from the original sheet and a second layer refers to the section that extends from the first inch to the second inch. An example of a layer based model is further described below.

### 2.2 Layer Based Model

FIG. 14B illustrates an example layer based model 1415. For input, the model receives a segment of a forming path 1420 and the initial geometry 1430 of a metal part (e.g., a sheet or other geometry). The segment of the forming path 1420 may include enough forming path to form a new layer of the part. The model outputs a resulting geometry 1425 (e.g., the geometry of the part with a new layer). Training data for this model may be generated by determining a forming path (e.g., set of parameter values) that formed a new layer of a part (e.g., scan every layer or every few layers).

Model 1415 may be developed as a sequence model which means it may be any of the sequence architectures (e.g., RNN, LSTM, Transformers). This model has more advantages than model 1400 since it is agnostic to general changes to the policy for forming robots. For example, model 1415 may be used to model inset adding or doing ADSIF or grouped DSIF. That being said, in some embodiments, model 1415 does not capture physical phenomena that may occur during each layer or group of layers.

### 3. Simulation

Referring back to FIG. 2B, the simulation module 225 simulates interaction of a robot-controlled tool, such as a stylus, with a sheet metal or other material. In one example, the simulation may be done using a finite element method. The simulation may be performed to generate simulation data indicating various input parameter values and resulting part geometries. The simulation may be replicated (e.g., in computer data centers) to generate large amounts of simulation data 230. The simulation speed and rate of data generation can be significantly enhanced using GPUs. The large amounts of data may be beneficial for training the model (e.g., instead of only relying on data generated from using a robot arm to physically deform a sheet).

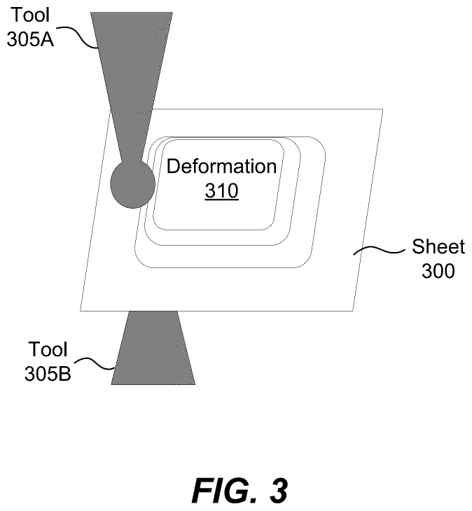

FIG. 3 illustrates an example image from a simulation. The image includes a three-dimensional simulation of a sheet 300 and two tools 305A and 305B interacting with the sheet. The tools may be coupled to robot arms. Tool 305A is interacting with the top surface of the sheet, and tool 305B (partially blocked by the sheet) is interacting with the bottom surface of the sheet. The tools are pressing into the sheet to form a deformation 310. In the example of FIG. 3, the deformation is a rectangular hill protruding upward.

Referring back to FIG. 2B, input for the simulation module 225 may be a specification for a sheet, such as its material properties (e.g., the stress-strain curve) and failure criteria (e.g., mechanical failure of the sheet). Failure criteria may be one or more rules that specify when a part has torn or cracked. The criteria may be based on thickness of the sheet, the material properties, and the amount strain put into the sheet. The simulation module may also receive a specification for one or more programmed forming paths (e.g., determined heuristically) and the type and size of the end effector (e.g., stylus). The simulation module outputs, for a sequence of time steps of the programmed control process, the resulting formed geometry.

By varying different input process parameters such as the forming path, its speed, and the geometry being formed, the simulation module 225 can generate a (e.g., large) data set indicating how a specific metal is deformed with this process (e.g., how metal deforms in response to certain input parameters). The simulation data is used to train a model (e.g., by a training module). The model may be trained using one or more different machine learning techniques and constructs, such as Neural Networks, Random Forests, Decision trees, or regressions. in some embodiments, the training techniques are supervised learning techniques.

In some embodiments, the simulation data is used to train an initial model. The initial model may then be refined or retrained using data from physical part forming processes to increase the accuracy of the model.

In the examples described above, the model is generally described in the context of forming operations. However, the model (or another model) may be trained to predict other part operations, such as trimming or hemming.

### 4. Instrumentation of Robotic Part Forming

The model created using simulation data may be further trained from data derived from an actual physical process that uses a robot arm and an actual sheet. The physical system is equipped with one or more different types of sensors. Example sensors include: (1) encoders in the robot joints that provide positional information as determined by the position of the joints, (2) optical trackers (e.g., a camera) that track the location of robot in (e.g., 3D) space, (3) surface scanners to generate as-built geometry of the part before, during, and after the forming process (surface scanners may have a point accuracy of 0.5 mm), (4) load sensors that determine the force the forming end effectors apply on the sheet, (5) ultrasonic sensors (e.g., electromagnetic acoustic transducer or EMAT) for real-time monitoring of material thickness, and (6) eddy current sensors (e.g., pulsed eddy current) for real-time monitoring of the metallurgical state of metallic sheet. In some embodiments, if the surface scanner is attached to the robot arm, surface scanner data may be stitched together based on the encoder data to determine the geometry of a part (the location of the scanner depends on the position of the arm).

The encoders may be attached to each joint on the robot to track its actual movement, the optical trackers may be mounted around the manufacturing cell. This allows the optical trackers to capture images that include tracking targets installed on the robotic arms and the frame holding the sheet in place. The load sensor and scanner may be attached to the end-of-arm tooling to track forming forces and deformation of the sheet during the process.

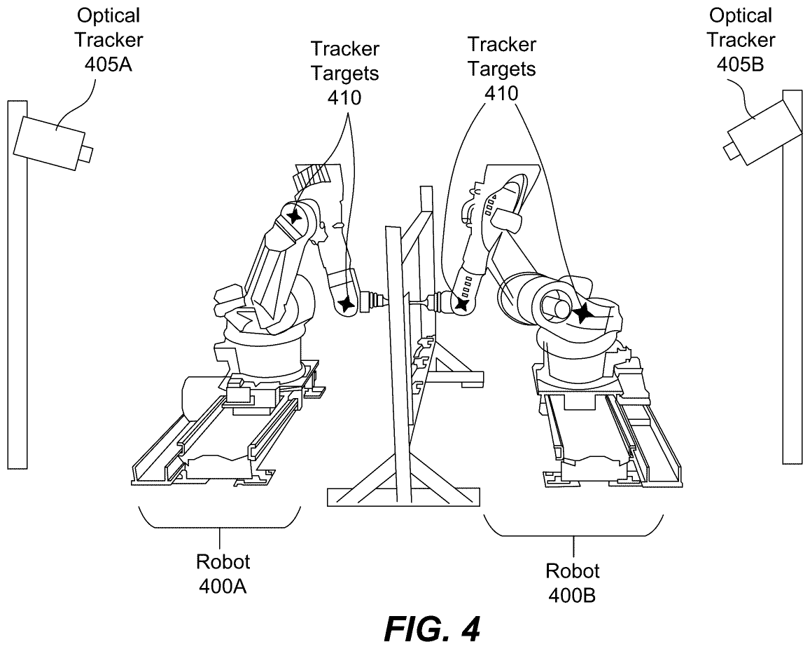

Example optical trackers are illustrated in FIG. 4. FIG. 4 includes two robots 400A and 400B in a manufacturing cell. FIG. 4 also includes two optical trackers 405A and 405B. The robots include tracker targets 410 located at various points on the robots. The optical trackers capture images of the robots and identify the locations of the tracker targets in the images. Thus, the locations of the robots in space can be determined. Although not illustrated, the sheet metal or frame may also include tracking targets to track locations of the robots relative to the metal sheet or frame.

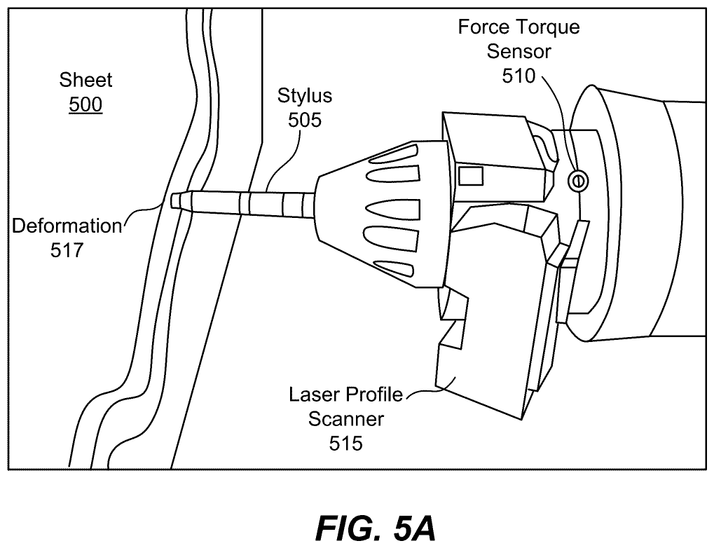

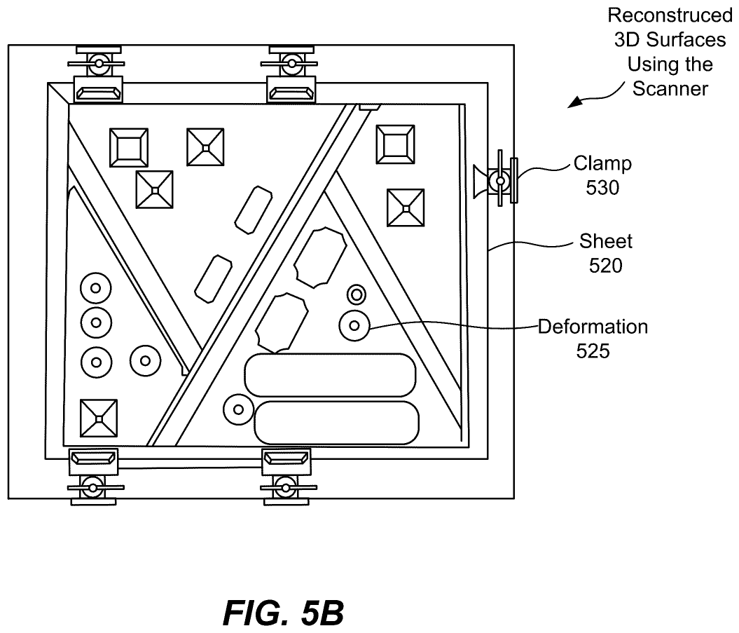

In some embodiments, the robot arm is outfitted with a scanner and a load sensor (e.g., force/torque sensor) as illustrated in FIG. 5A. FIG. 5A illustrates a zoomed in view of an end of a robot arm. The robot arm interacts with a metal sheet 500 via a stylus 505 to create a deformation 517. The arm also includes a force torque sensor 510 and a laser profile scanner 515. FIG. 5B is an example image generated using data from the laser profile scanner 515. FIG. 5B illustrates a reconstructed three-dimensional surface of the metal sheet. The image includes clamps 530, a sheet 520, and deformations 525 in the sheet.

With the sensors described above, accurate data can be captured to characterize steps of a part forming process.

Referring back to FIG. 2B, the training module 235 obtains data 230 generated by the simulation module 225 (e.g., parameters and estimated final geometry of a part for a given forming process), sensor data 265 generated during a part forming process, and data 240 generated during a post-build inspection 245 (e.g., actual final geometry of the part). The training module 235 trains a machine-learned model 200 that maps input parameters to a resulting geometry.

### 5. Using the Model in Control Loop

Once a process model 200 is generated using the above-described training process, the model may be applied in the control process of the robotic forming in two ways. The model may as an input takes a specification for a sheet, such as its material properties (e.g., stress-strain curve) and failure criteria. It may also receive a specification for forming paths (which may initially be determined offline) and the type and size of the tool. The model can be either queried online for optimized process parameters for each time step of the process in real-time, or it can be used in the design of experiments offline to determine optimal policy for forming the part. The policy here refers to general pathing strategies in forming a part.

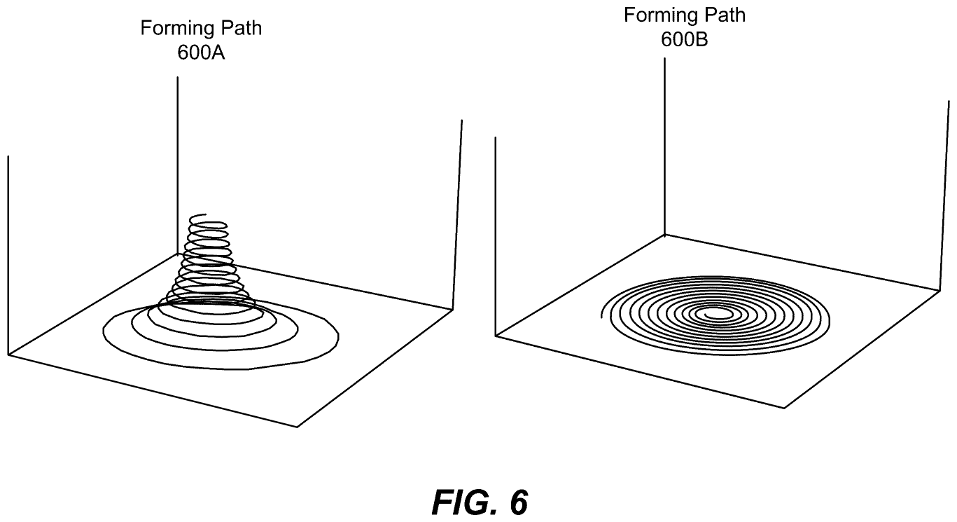

FIG. 6 illustrates two different strategies for forming a cone in an example forming process. Both can be evaluated (e.g., by the controller 255) using the machine-learned model 200 to determine a preferred path. The model can also be used (e.g., by the controller 255) to determine a combination of strategies for different locations in the part that might yield the best outcome. On the left side of FIG. 6 is a depiction of a forming path 600A that starts the forming from outside and moves in a circular pattern toward the inside of a cone (first forming the largest radius and then moving toward forming a smaller radii). On the right side of FIG. 6 is depiction of a forming path 600B that starts forming from inside and moves in a circular pattern toward the outside of a cone (first forming the tip of the cone with the smallest radius and then progressively forming larger and larger radii). The model can be used predict the outcome of both strategies to determine the best strategy or their combination for different parts.

Two categories of systems discussed below may increase the speed of sheet metal part fabrication using robots. The first system and design (“Forming With Rollers”) increases the speed of the forming process itself, while the second (“Integration of Downstream Processes”) addresses downstream processes from part forming to decrease total fabrication time.

### 6. Forming with Rollers

To increase the speed of the part forming process, an end-effector tool may be configured to interact with the sheet metal with reduced (e.g., low) friction forces. Reducing friction allows for reduction in vibrations in the sheet and hence allows increased speed of forming without negative impact on the geometrical accuracy of the formed part. It may also result in better surface quality (e.g., reduced tearing and galling) compared to tools not configured to reduce friction (e.g., static forming tools).

An example tool configured to reduce friction is a stylus made of a material (or coated with a material) configured to reduce friction. Thus, if the stylus is dragged across the surface of a part, the reduced friction may reduce or eliminate surface degradations and increase the path speed.

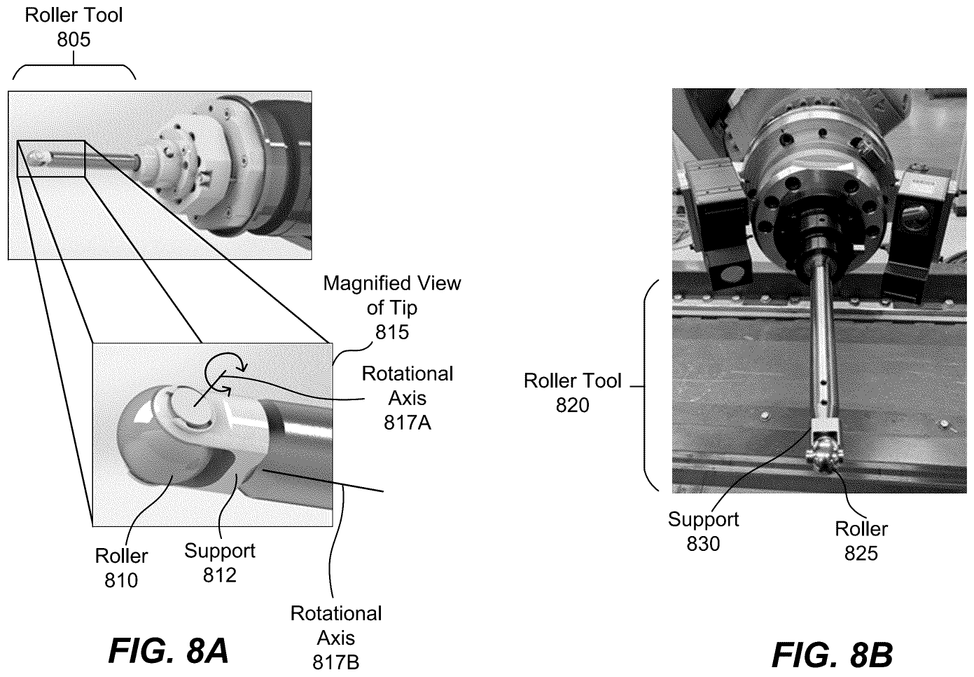

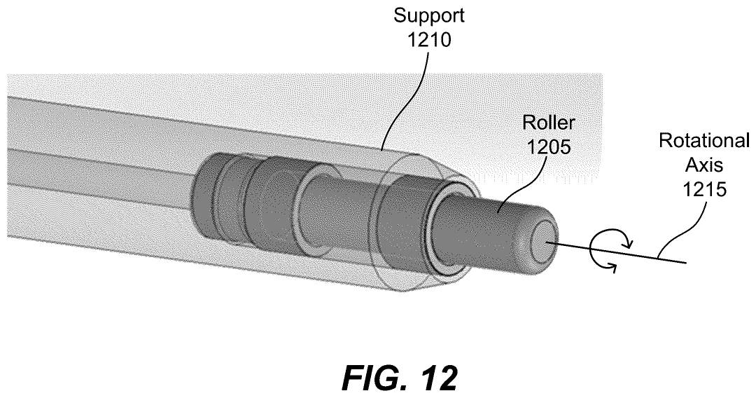

Other tools configured to reduce friction may include roller tools. Roller tools may result in lower friction forces than a stylus. Different rollers with different radii and shape can be used to accommodate for different features in the part design. FIGS. 8A-8B illustrate example embodiments of roller tools. FIG. 8A includes an image of a roller tool 805 coupled to a robot arm and a magnified view of the tip of the roller tool 815. The tip of the roller tool includes a roller 810 held in place by a support 812. The support allows the roller to rotate about an axis 817. FIG. 8B is an image of a larger roller tool 820. Similar to FIG. 8A, tool 820 has a roller 825 and a support 830. Another example of a single axis roller is illustrated in FIG. 12. The tool includes a roller 1205 with a support 1210. The roller can rotate about axis 1215, which is parallel to a long axis of the support.

In some embodiments, the roller can only roller about a single rotational axis (e.g., as in FIGS. 8A and 8B). However, the robotic system is controlled, via the controller, to orient the roller tool so that the roller rolls along the desired direction of movement (the desired direction of movement may be set by the program). Said differently, the roller tool may be oriented so that the rotational axis of the roller is perpendicular to the direction of movement of the roller tool. The illustrated rollers are specifically suitable for part forming with articulated 6-axis robots, since the robots can take advantage of the 6 degrees of freedom to align a roller in the direction of the movement during part forming. The roller may be held with the same mechanism as the stylus or other tools using a tool holder that is mounted at the end of the robotic arm.

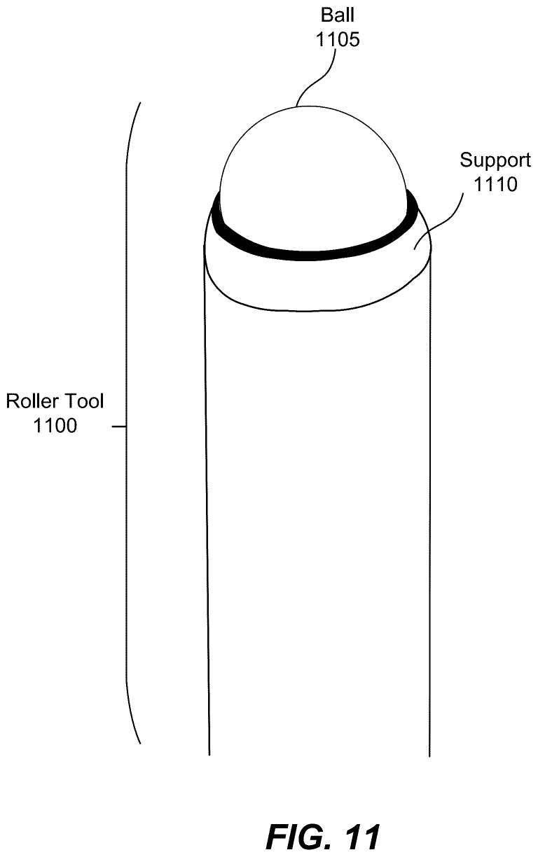

In some embodiments, a roller tool includes a roller that can rotate about multiple rotational axes. An example, of this is illustrated in FIG. 11. FIG. 11 includes a roller tool 1100. The tool 1100 includes a ball 1105 in a socket that may be part of a support 1110 for the ball. The ball can rotate in the socket. Thus, the tool can move in different directions along a part surface without the robot rotating the support along the long axis. Due to the socket configuration, the roller tool 1100 have less friction than a stylus but more friction than a single axis roller (e.g., as illustrated in FIGS. 8A and 8B).

The disclosed roller design installed on a robotic setup allows for robotic part forming with reduceds friction, hence reduced forces which then allows for better surface quality of the formed part and increased speed of the forming process.

### 7. Integration of Downstream Processes in the Forming Setup

Sheet metal part forming may be one of many manufacturing steps performed to produce a final sheet metal part. For example, a sheet metal part also goes through trimming, hole making, hemming, or other processing steps after the part forming process. Traditional methods involve transferring a sheet metal part from one specialized manufacturing station to another, performing each manufacturing step in each corresponding station to produce the delivering the final part. This results in increased manufacturing time due to the time for physically moving the part from one station to another.

Each of the downstream processes generally has its own specific tooling. For example, for trimming a part, it is desirable to use a geometry specific frame that can hold the geometry of the part while a trimming operation is performed.

In some embodiments, the robotic system allows for performing two or more (e.g., all) downstream manufacturing steps in the same station using the same robotic setup, thus avoiding moving of the part and decreasing the total fabrication time. Each downstream process may use a different tool. For example, when performing trimming (e.g., hole making), the robot arm may attach different tools such as a spindle, laser, or a plasma torch. The robotic arm can be controlled to automatically change the tool through software instructions of the program executed by the controller (e.g., controller 255). For example, the controller can control the robot arm at varying times throughout the process to perform a programmed operation on the sheet metal with a particular tool, to control an actuator to release a tool from the tool holder (e.g., into a tool rack), and to cause the robot arm to attach a new tool from the tool holder (e.g., from the tool rack) for performing a subsequent operation.

In some embodiments, the steps that enable automatic integration of downstream processes in the same station may include the following. (1) the robot goes to a tool rack and picks up a forming tool (e.g., a stylus) using predefined software instructions sent to the robot. (2) the robot forms a part from a flat sheet of metal through software defined path and parameters. (3) After the part is formed, the robot moves back to the tool rack, disengages (e.g., drops) the forming tool, and picks up a trimming tool. This step may also be automated with software instructions. (4) The robot performs a trimming operation on the part with the trimming tool. If further downstream processes, such as hemming (e.g., bending), are used to finish the part, the system may continue from step 3 until no more processes are left to perform. If a station includes multiple robots, the robots may work in conjunction using the same or different tools to achieve a desired process (e.g., a forming or trimming process).

If a manufacturing area includes multiple cells (e.g., each including two robot arms), instead of each cell changing tools to perform different operations, each cell may be assigned to a specific operation. In these embodiments, a part may be moved from one cell to another after each operation on the part is complete.

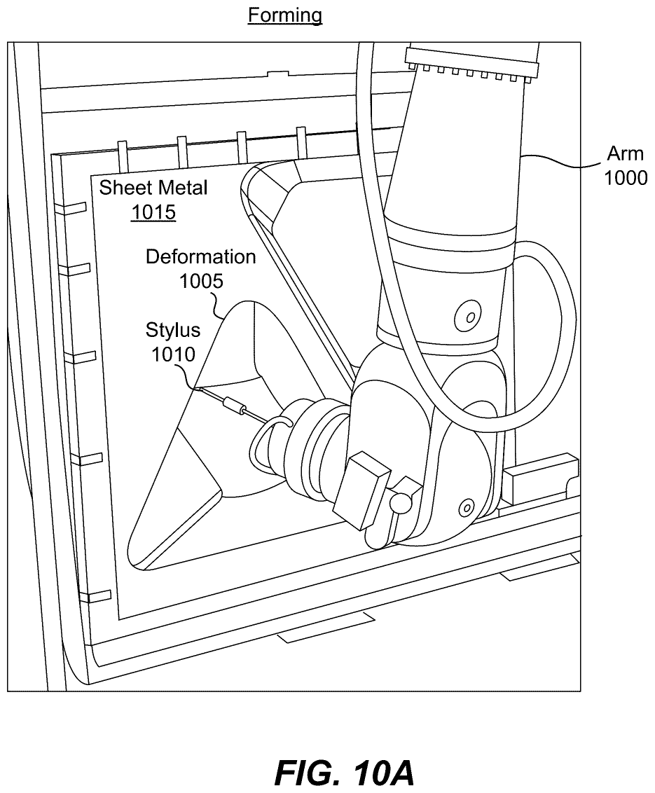

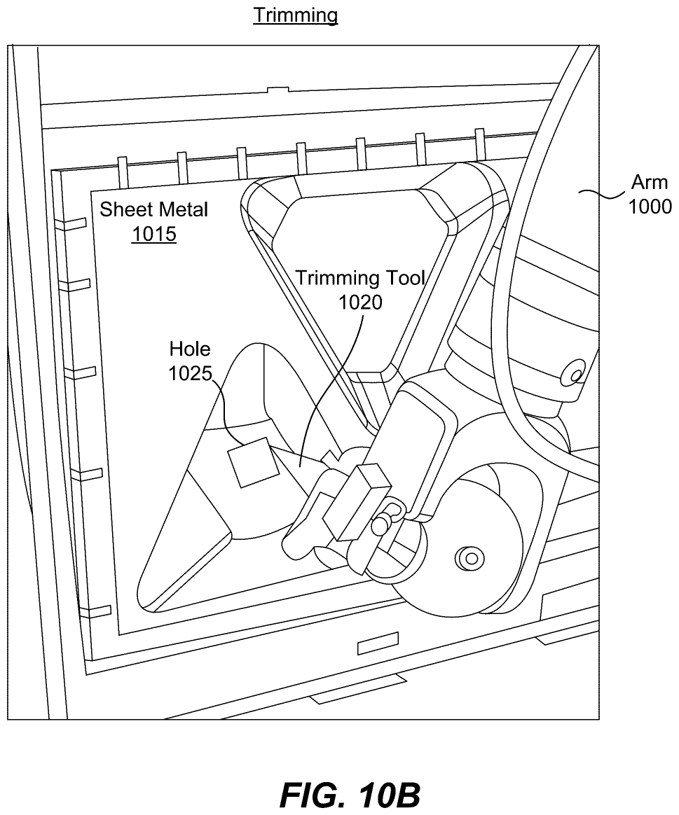

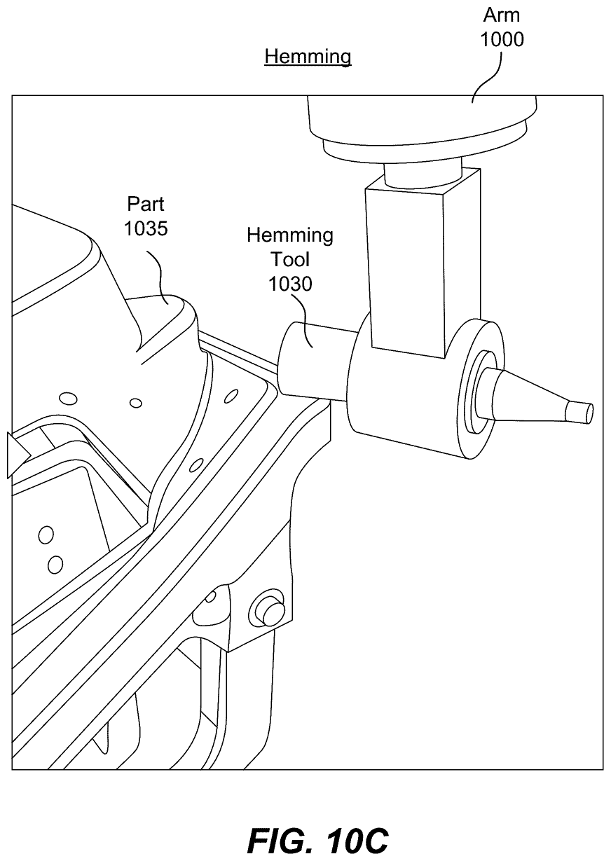

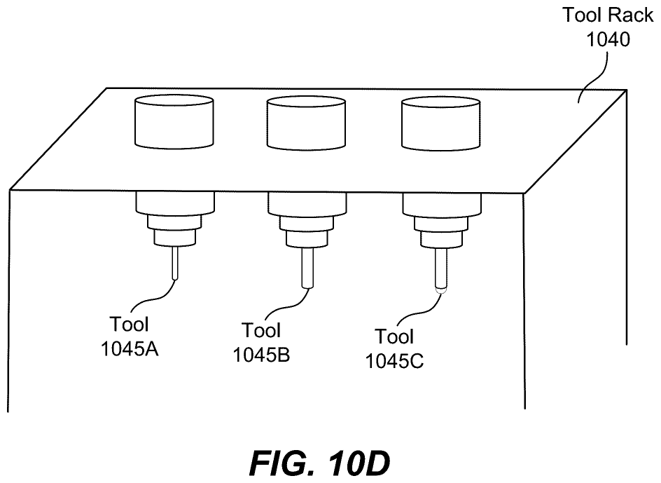

FIG. 10 includes images of various manufacturing processes described above. FIG. 10A illustrates a robot arm 1000 forming a deformation 1005 by pressing a stylus 1010 against a piece of sheet metal 1015. FIG. 10B illustrates the robot arm 1000 with a trimming tool 1020. The trimming tool is used to cut a hole 1025 in a portion of the deformation. To determine the location of the hole, a controller of the arm (e.g., controller 255) may compare a design of the deformation (e.g., in a computer-aided design file) with the current geometry of the deformation (the current geometry may be determined from sensor data). For example, after the deformation is formed, the robot picks up a scanner sensor, scans the deformation and, based on a design of the deformation, determines the path to trim the deformation. After that, the robot may pick up a trimming tool. FIG. 10C illustrates the robot arm 1000 with a hemming tool 1030. The hemming tool is used to bend a corner of a part 1035. FIG. 10D is a perspective view of a tool rack 1040 holding a plurality of tools 1045. The rack may be placed near a robot arm (e.g., arm 1000) so that the arm can exchange tools. In the example of FIG. 10D, tools 1045A and 1045B are styli and tool 1045C is a roller tool.

### 8. Frame

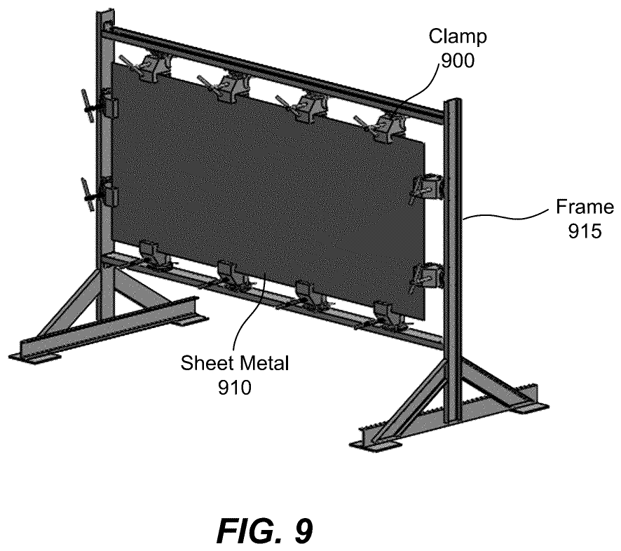

FIG. 9 is a perspective view of a frame 915 (also referred to as a fixture), according to an embodiment. In the example of FIG. 9, the frame 915 includes a series of clamps 900 that hold the sheet metal 910 in place. Specifically, the frame surrounds the edges of the sheet metal and the clamps are clamped to edge portions of the sheet metal 910. The clamps may be hydraulic or electric (e.g., servo). The clamps may be electronically operated. The frame and clamps may be sturdy enough to hold the sheet metal in place as the robot arms apply different processes (e.g., deformation forces) to the sheet. The frame enables access to large sections of the sheet metal 910 with robotic arms. Thus, it may eliminate the need for any method-specific modification in the fixture that is traditionally required with downstream operation from sheet forming.

Thus, the stand design and software-controlled tool changer for controlling the robotic arms allows for automated downstream operations from forming of the sheet metal parts such as trimming, bending, and hemming without removing the part from the fixture and requiring geometry specific fixture.

### 9. Mechanical Clamps

Some embodiments relate to a mechanical clamp configured to hold an object (e.g., a sheet of metal) that may be integrated into a frame (e.g., frame 115 or 915).

FIGS. 16A-16K (“FIG. 16” collectively) are diagrams of a mechanical clamp 1600, according to an embodiment. FIG. 16A is a perspective view of the clamp 1600, where the clamp is in an open position. FIG. 16B is a perspective view of the mechanical clamp 1600, where the clamp is in a closed position (with no object in the clamp). FIG. 16C is a perspective view of the mechanical clamp 1600, where the clamp is in a closed position (holding an object that is not illustrated). FIG. 16D is an exploded view of the mechanical clamp 1600. FIGS. 16E-16F are rear view perspective diagrams of the clamp 1600 in different clamping positions (note that the bottom clamp interface 1605 is omitted). FIG. 16E illustrates the clamp in an open position, FIG. 16G illustrates the clamp in a closed position, and FIG. 16F illustrates the clamp in an intermediate position. FIGS. 16H-16I are side views of the claim 1600 in different positions (note that the bottom clamp interface 1605 is omitted). FIG. 16J illustrates the clamp 1600 in a clamp frame 1650. More specifically, FIG. 16J includes views of the clamp 1600 (in the clamp frame 1650) in three different positions. In the left diagram, the clamp 1600 is in an open position. In the right diagram, the clamp 1600 is in a closed position with no object in the clamp 1600. In the middle diagram, the clamp 1600 is in a closed position with object 1666 in the clamp. The clamp frame 1650 houses the clamp 1600 (it may house additional clamps as well). FIG. 16J additionally illustrates an alignment angle 1655 that is the angle formed between compression axis 1656 and base link axis 1657. FIG. 16K provides a perspective view of the clamp 1600 the clamp frame 1650 (the left diagram illustrates the clamp 1600 in a closed position and the right diagram illustrates the clamp 1600 in an open position). FIG. 16K additionally indicates a link pivot point 1651, a clamp pivot point 1652, and an actuator pivot point 1653 (a pivot point may be formed via coupling elements that form a joint (e.g., by the coupling elements interlocking and a pin inserted through the coupling elements)).

Clamp 1600 includes actuator 1607, base link 1611, clamp arm 1602, and compressible link 1606.

Actuator 1607 is a device that converts energy (e.g., electrical or hydraulic) into physical motion (e.g., actuator 1607 is or includes a hydraulic or pneumatic cylinder). First actuator end 1613 can extend or retract. A second end of actuator 1607 is coupled to clamp frame 1650 via actuator pivot point 1653 and can rotate about the actuator pivot point 1653 (e.g., compare the actuator position in the left and right diagrams of FIG. 16K).

Base link 1611 is a link of material (e.g., metal) with first link end 1612 and second link end 1610. The base link 1611 is coupled to the clamp frame 1650 via the link pivot point 1651 and can rotate about the link pivot point 1651 (e.g., compare the base link 1611 position in the left and right diagrams). More specifically, first link end 1612 is part of a hinge that couples base link 1611 to clamp frame 1650. The hinge forms link pivot point 1651 and enables second link end 1610 to rotate about link pivot point 1651. Second link end 1610 is movably (e.g., rotatably) coupled to first actuator end 1613. Thus, extension or retraction of first actuator end 1613 results in second link end 1610 rotating about link pivot point 1651.

Clamp arm 1602 includes clamp interface 1601, first arm coupling element 1603, and second arm coupling element 1604. Clamp interface 1601 is configured to interface with a surface of the object to be held. For example, clamp interface 1601 is a bar of material (e.g., metal). Clamp arm 1602 is coupled to the clamp frame 1650 via the clamp pivot point 1652 and can rotate about the clamp pivot point 1652 (e.g., compare the clamp arm 1602 position in the left and right diagrams). More specifically, second arm coupling element 1604 is part of a hinge that couples clamp arm 1602 to clamp frame 1650. The hinge forms clamp pivot point 1652 and enables clamp interface 1601 and first arm coupling element 1603 to rotate about clamp pivot point 1652.

Although the pivot points described above are relative to clamp frame 1650, this is not required. For example, a component (e.g., base link 1611) may form a pivot point (e.g., link pivot point 1651) with another component or object.

Compressible link 1606 includes pivot link 1609 and spring 1608. Compressible link 1606 is a link that couples clamp arm 1602 to base link 1611. More specifically, compressible link 1606 couples first arm coupling element 1603 of clamp arm 1602 to second link end 1610 of base link 1611. Compressible link 1606 includes one or more components (e.g., spring 1608) that can compress along compression axis 1656 (e.g., see FIG. 16J). Examples of compressible link 1606 compressed are illustrated in FIG. 16C and the middle diagram of FIG. 16J (notice the springs are compressed).

The stiffness of spring 1608 may depend on the type of object to be held and the number of springs in compressible link 1606. In the example of FIG. 16, spring 1608 is a helical spring. However, any variation of spring may be used, such as a torsion spring or leaf spring. In FIG. 16, a set of four springs are illustrated. However, additional or fewer springs may be used.

Pivot link 1609 is a link with (a) first portion 1630 that couples with second link end 1610 to form a hinge (that enables rotation) and (b) a second portion 1632 (e.g., a plate with a hole) configured to press against spring 1608.

Clamp 1600 may include bottom clamp interface 1605 configured to interface with a surface of the object to be held. For example, bottom clamp interface 1605 is a bar of material (e.g., metal). Thus, an object held by clamp 1600 may be held between bottom clamp interface 1605 and clamp interface 1601.

In the clamp open position, first actuator end 1613 is in a retracted position. In the open position, alignment angle 1655 is small (e.g., see left diagram of FIG. 16J). To close clamp 1600, first actuator end 1613 is extended (upward in the perspective of FIG. 16J). Extension of first actuator end 1613 causes second link end 1610 to rotate (e.g., counterclockwise in the perspective of FIG. 16J). Rotation of second link end 1610 causes compressible link 1606 to apply a force to clamp arm 1602 to rotate it about clamp pivot point 1652 (e.g., clockwise in the perspective of FIG. 16J). During closing motion alignment angle 1655 increases. Example closing motions may be seen by viewing the transition from FIG. 16A to FIG. 16B or 16C, the transition from FIG. 16E to 16G, the transition from the left diagram of FIG. 16J to the middle or right diagram of FIG. 16J, or the transition from the left diagram of FIG. 16K to the right diagram of FIG. 16K.

During closing motion, if no object is positioned between clamp interface 1601 and bottom clamp interface 1605, clamp arm 1602 continues to rotate until clamp interface 1601 contacts bottom clamp interface 1605 and/or first actuator end 1613 reaches an end extension position. However, if an object is positioned between clamp interface 1601 and bottom clamp interface 1605 during closing motion, clamp arm 1602 rotates until clamp interface 1601 contacts the object. After contact, compressible link 1606 may compress as first actuator end 1613 continues to extend, thus applying a clamping force to the object.

Among other advantages, clamp 1600 may apply a stronger clamping force on thicker objects due to the compressible link being further compressed for thicker objects. This is advantageous because thicker objects are typically heavier and thus require stronger forces to hold them in place.

In some embodiments, clamp 1600 includes a locked closed position due the components forming an over center mechanism. In the locked closed position, clamp 1600 may remain in the closed position even if actuator 1607 applies little or no force to keep first actuator end 1613 at the extended position or to move first actuator end 1613 to a further extended position. For example, in the locked closed position, clamp 1600 may remain closed even if actuator 1607 fails. The locked closed position may occur when alignment angle 1655 is larger than 180 degrees. After alignment angle 1655 is larger than 180 degrees, compressible link 1606 applies a force to continue rotating base link 1611 in the closed direction (which is counterclockwise in the perspective of FIG. 16J). Note that base link 1611 may be prevented from continuing to rotate in the closed direction past a threshold point, for example due to first actuator end 1613 reaching a maximum extended position or due to another mechanism that prevents further rotation of base link 1611.

The locked closed position is also advantageous because it results in clamp 1600 applying a consistent clamping pressure. More specifically, in the locked closed position, the clamping pressure is from the force applied by compressible link 1606, which may be consistent and reliable. This contrasts with conventional clamps that rely on a hydraulic cylinder to apply the clamping pressure (since hydraulic cylinders may be less reliable and less consistent than the clamping force applied by compressible link 1606).

Clamp 1600 may be modified in many ways but still achieve similar advantages. For example, instead of actuator 1607 being located below base link 1611, actuator 1607 may be above base link 1611 (e.g., in the perspective of FIG. 16J). In this configuration, the open clamp position may correspond to first actuator end 1613 being in an extended position and the closed clamp position may correspond to first actuator end 1613 being in a retracted position.

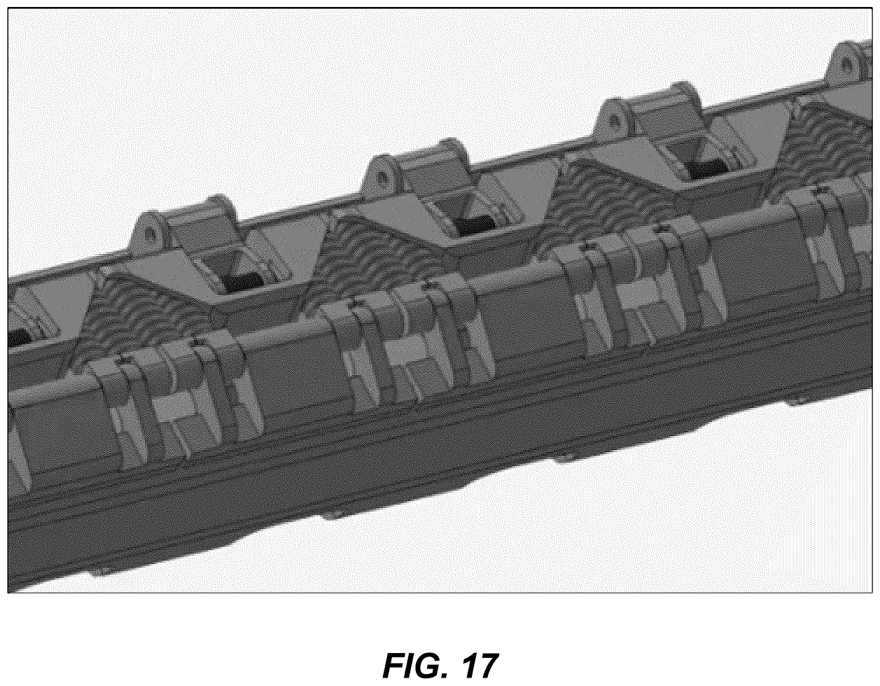

FIG. 17 is a perspective diagram that illustrates an example series of clamps (e.g., including clamp 1600) adjacent to each other on a side of a frame (e.g., frame 115, 910).

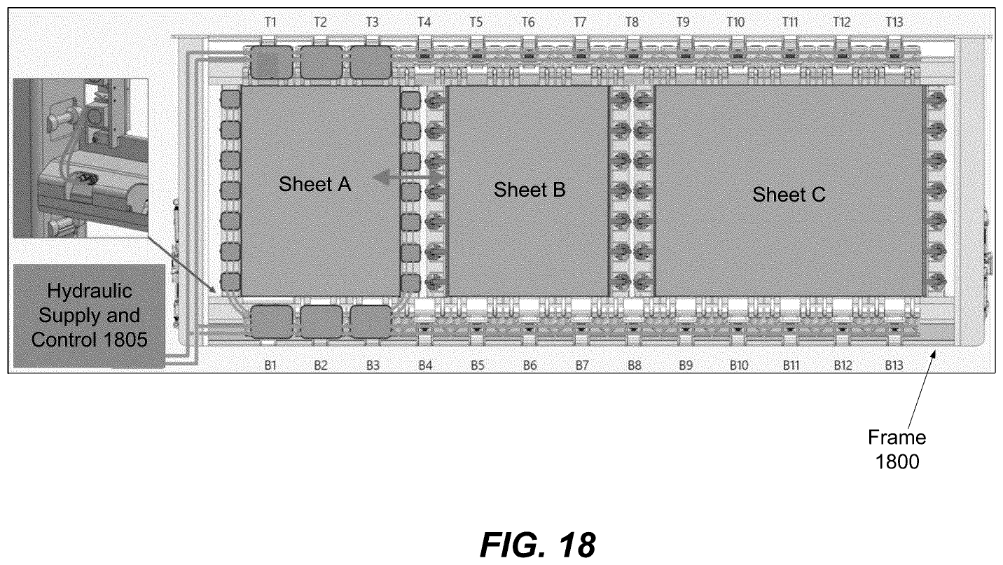

FIG. 18 is a diagram of an example frame 1800 that includes clamps around the edges (e.g., including clamp 1600). The clamps are holding three different metal sheets (labeled sheet A, sheet B, and sheet C). Clamps along the top portion of the frame 1800 are labeled T1-T13. Clamps along the bottom portion of the frame 1800 are labeled B1-B13. Each of the clamps on the top and bottom portions can be independently controlled via the hydraulic supply and control system 1805. Among other advantages, independently controlling clamps enables frame 1800 to independently hold multiple objects at once (three metal sheets in this example). For example, sheet A can be released from frame 1800 while sheets B and C continue to be held in place.

Frame 1800 also includes vertical bars of clamps (not labeled). These vertical bars may be repositionable on frame 1800 to enable frame 1800 to hold objects of different sizes. Each of the clamps on a vertical bar may be independently controlled by the hydraulic supply and control system 1805. However, in some embodiments, clamps on a vertical bar (“vertical clamps”) may be coupled to a clamp on the top or bottom portion (“horizontal clamp”) to enable the vertical clamps to be opened or closed with the corresponding horizontal clamp.

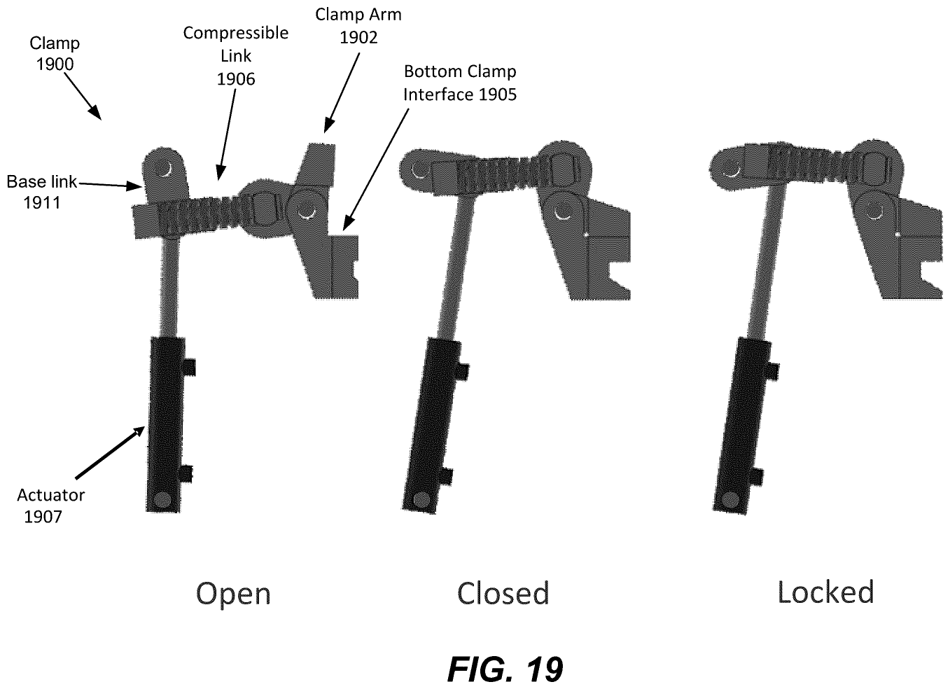

FIG. 19 illustrates diagrams of another example clamp 1900. The left diagram illustrates the clamp 1900 in an open position, the middle diagram illustrates the clamp 1900 in a closed position, and the right diagram illustrates the clamp 1900 in a closed locked position. Similar to clamp 1600, clamp 1900 includes an actuator 1907, a base link 1911, a compressible link 1906, a clamp arm 1902 and a bottom clamp interface 1905.

### 10. Additional Example Clamps

Additional example embodiments of clamps are described below. Although references are made to previous clamps (e.g., 1600) in the below descriptions, the example embodiments described below are not required to include the components or features previously described.

Some aspects relate to a mechanical clamp (e.g., clamp 1600) configured to hold an object, the mechanical clamp including: an actuator (e.g., 1607) having an end (e.g. 1613) that is movable; a base link (e.g., 1611) with a first link end (e.g., 1612) configured to be movably coupled to a link pivot point (e.g., 1653) and with a second link end (e.g., 1610) movably coupled to the end of the actuator, movement of the end of the actuator to cause the second link end to rotate about the link pivot point; a clamp arm (e.g., 1602) including: a front clamp interface (e.g., 1601) configured to interface with a surface of the object to be held (e.g., object 1666); a first arm coupling element (e.g., 1603); and a second arm coupling element (e.g., 1604) mounted to a clamp pivot point (e.g., 1652), the first arm coupling element and the clamp interface configured to rotate about the clamp pivot point; and a compressible link (e.g., 1606) (e.g., with a spring) configured to compress along a compression axis, the compressible link coupling the second link end with the first arm coupling element, rotation of the second link end about the link pivot point to cause the compressible link to exert force against the first arm coupling element.

As previously described, the mechanical clamp comprises components that work together to hold an object securely in place (in other embodiments, similar or different variations of component types may be used). The mechanical clamp operates (in part) by rotating about the link pivot point. When the actuator is pushed in an open position (as further illustrated in FIG. 16J), the base link rotates about the link pivot point (e.g., 1651). This rotation may compress the compressible link which, in turn, may apply force to the clamp arm. As a result, the clamp arm may press onto an object to secure it.

In some aspects, the techniques described herein relate to a mechanical clamp, wherein the second link end rotation about the link pivot point causes the compressible link to exert force against the first arm coupling element in a rotation direction about the clamp pivot point.

In some aspects, the techniques described herein relate to a mechanical clamp, wherein (a) rotation of the second link end about the link pivot point in a first direction and (b) the clamp interface in contact with the object causes the compressible link to compress along the compression axis (e.g., see the middle diagram of FIG. 16J where the springs are compressed). In the perspective of FIG. 16J, the second link end may rotate about the link pivot point in a counterclockwise direction. However, the second link end may rotate about the link pivot point in multiple directions—such as clockwise.

In some aspects, the techniques described herein relate to a mechanical claim, wherein (a) rotation of the second link end about the link pivot point in a second direction different than the first direction and (b) the clamp interface in contact with the object causes the compressible link to decompress along the compression axis (e.g., the transition from the middle diagram of FIG. 16J to the left diagram of FIG. 16J. In this situation, the second link end rotates about the link pivot point in a clockwise direction, which results in the compressible link (e.g., the spring 1608) decompressing.

In some aspects, the techniques described herein relate to a mechanical clamp, wherein (a) rotation of the second link end about the link pivot point in a second direction different than the first direction and (b) the clamp interface in contact with the object causes the first arm coupling element and the clamp interface to rotate about the clamp pivot point.

In some aspects, the techniques described herein relate to a mechanical clamp, wherein (a) rotation of the second link end about the link pivot point and (b) the absence of contact between the clamp interface and the object causes the first arm coupling element and the clamp interface to rotate about the clamp pivot point.

In some aspects, the techniques described herein relate to a mechanical clamp, wherein the second link end rotation about the link pivot point causes an alignment angle (e.g., alignment angle 1655) between (a) an axis extending between the first link end and the second link end (e.g., a base link axis 1657 illustrated in FIG. 16J) and (b) the compression axis (e.g., a compression axis 1656 illustrated in FIG. 16J) to increase or decrease.

In some aspects, the techniques described herein relate to a mechanical clamp, wherein the base link, the clamp arm, and the compressible link form an over-center mechanism. The over-center mechanism may locks into position after it is of a certain alignment angle. This is advantageous because this allows for the mechanical clamp to lock in place in a closed position, providing a secure and stable hold. In application, this can allow for the mechanical clamp to securely hold objects.

In some aspects, the techniques described herein relate to a mechanical clamp, further including a second clamp arm (e.g., that includes bottom clamp interface 1605) including: a second clamp interface configured to interface with a second surface of the object to be held; and the clamp pivot point.

In some aspects, the techniques described herein relate to a mechanical clamp, wherein the compressible link includes: a pivot link (e.g., 1609) coupled to the second link end; and a spring (e.g., 1608) with a first end coupled to the first arm coupling element and a second end coupled to the pivot link.

In some aspects, the techniques described herein relate to a mechanical clamp, wherein the pivot link and the second link end of the base link form a joint (e.g., a hinge).

In some aspects, the techniques described herein relate to a mechanical clamp, wherein the clamp interface is part of a clamp bar.

In some aspects, the techniques described herein relate to a mechanical clamp, wherein a clamping force of the mechanical clamp depends on a thickness of the object.

In some aspects, the techniques described herein relate to a mechanical clamp, wherein the clamping force of the mechanical clamp increases with increasing thickness.

In some aspects, the techniques described herein relate to a mechanical clamp, wherein: the actuator is controlled to move the end between a first position and a second position; and wherein the mechanical clamp is configured to hold objects of different thicknesses by the actuator moving the end from the first position to the second position.

In some aspects, the techniques described herein relate to a mechanical clamp, wherein: object has a first thickness, and the mechanical clamp is configured to hold the object by the actuator moving the end from a first position to a second position; and a second object has a second thickness different that the first thickness, and the mechanical clamp is configured to hold the second object by the actuator moving the end from the first position to the second position.

In some aspects, the techniques described herein relate to a clamping system including: a set of two or more mechanical clamps, at least one mechanical clamp of the set including: an actuator having an end that is movable; a base link with a first link end coupled to a link pivot point and a second link end coupled to the end of the actuator, movement of the end of the actuator causing the second link end to rotate about the link pivot point; a clamp arm including: a clamp interface configured to interface with an object to be held; a first arm coupling element; and a second arm coupling element mounted to a clamp pivot point, the first arm coupling element and the clamp interface configured to rotate about the clamp pivot point; and a compressible link configured to compress along a compression axis, the compressible link coupling the second link end with the first arm coupling element, rotation of the second link end about the link pivot point causing the compressible link to exert force against the first arm coupling element; and a control system configured to control the set of clamps.

In some aspects, the techniques described herein relate to a clamping system, wherein each of the mechanical clamps in the set include an actuator, a base link, a clamp arm, and a compressible link.

In some aspects, the techniques described herein relate to a clamping system, wherein the set of further including a clamp bar shared by the mechanical clamps in the set, wherein each of the clamp arms of the mechanical clamps in the set are configured to rotate toward the clamp bar to hold an object.

In some aspects, the techniques described herein relate to a clamping system, wherein: the set of clamps are arranged on a rectangular frame; and the set of clamps includes: a first subset of clamps arranged on a bottom portion of the rectangular frame; a second subset of clamps arranged on a top portion of the rectangular frame; a third subset of clamps arranged on a first vertical portion of the rectangular frame; and a fourth subset of clamps arranges on a second vertical portion of the rectangular frame, wherein: the control system is configured to individually control each of the clamps in the first subset and in the second subset; control of the third subset of clamps is based on control of a first clamp in the first subset or the second subset; and control of the fourth subset of clamps is based on control of a second clamp in the first subset or the second subset.

In some aspects, the techniques described herein relate to a system of clamps to passively clamp an object, the system including: a clamp bar; a hydraulic center; a pivot link coupled to a base link to: receive a coupling of preloaded springs for a clamping bar; receive pressure from the hydraulic center; and apply pressure from the hydraulic center to the clamp bar; a base link coupled to the pivot link, the pivot link configured to: (i) apply the pressure from the hydraulic center to the clamp bar, wherein the pivot link bar and the clamping bar are orthogonal to the hydraulic center; and (ii) apply pressure to close the clamping bar.

Other aspects include components, devices, systems, improvements, methods, processes, applications, computer readable mediums, and other technologies related to any of the above.

### 11. Example Machine Architecture

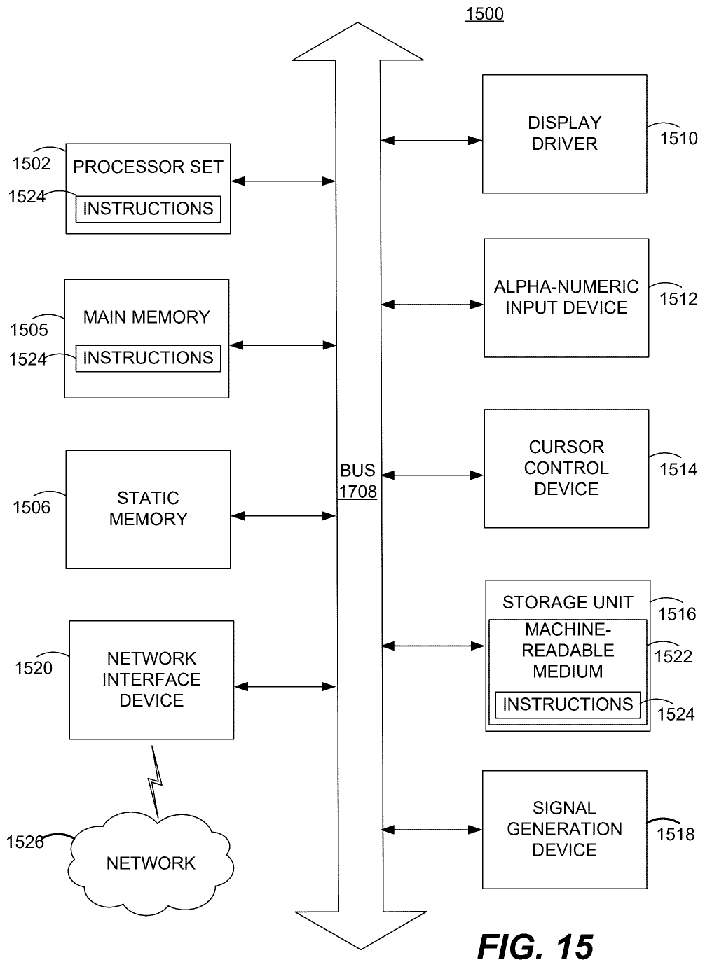

In some embodiments, the controller (e.g., controller 255 or controller 1120) is a machine able to read instructions from a machine-readable medium and execute them in a set of one or more processors. FIG. 15 is a block diagram illustrating components of an example machine able to read instructions from a machine-readable medium and execute them in a set of one or more processors. Specifically, FIG. 15 shows a diagrammatic representation of a machine in the example form of a computer system 1500. The computer system 1500 can be used to execute instructions 1524 (e.g., program code or software) for causing the machine to perform any one or more of the methodologies (or processes) described herein. In alternative embodiments, the machine operates as a standalone device or a coupled (e.g., networked) device that connects to other machines. In a networked deployment, the machine may operate in the capacity of a server machine or a client machine in a server-client network environment, or as a peer machine in a peer-to-peer (or distributed) network environment. Here, the robots, e.g., 400A, 400B, and other automated components may include all or a portion of the component of the described computer system (or machine) 1500. The robots, e.g., 400A, 400B, and/or other automated components may be programmed with program code to operate as described with FIGS. 1-14B. Such operation also include program code corresponding to the disclosed models, e.g., 1400, 1415, for effecting the resulting geometries through the robots, e.g., 400A, 400B and other automated components.

The machine may be a server computer, a client computer, a personal computer (PC), a tablet PC, a smartphone, an internet of things (IoT) appliance, a network router, or any machine capable of executing instructions 1524 (sequential or otherwise) that specify actions to be taken by that machine. Further, while only a single machine is illustrated, the term “machine” shall also be taken to include any collection of machines that individually or jointly execute instructions 1524 to perform any one or more of the methodologies discussed herein.

The example computer system 1500 includes a set of one or more processing units 1502. The processor set 1502 is, for example, one or more central processing units (CPUs), one or more graphics processing units (GPUs), one or more digital signal processors (DSPs), one or more state machines, one or more application specific integrated circuits (ASICs), one or more radio-frequency integrated circuits (RFICs), or any combination of these. If the processor set 1502 include multiple processors, the processors may operate individually or collectively. The processor set 1502 also may be a controller. The controller may include a non-transitory computer readable storage medium that may store program code to operate (or control) the robots, e.g., 400A, 400B, and/or other automated components described herein.

For convenience, the processor 1502 is referred to as a single entity but it should be understood that the corresponding functionality may be distributed among multiple processors using various ways, including using multi-core processors, assigning certain operations to specialized processors (e.g., graphics processing units), and dividing operations across a distributed computing environment. Any reference to a processor 1502 should be construed to include such architectures.

The computer system 1500 also includes a main memory 1504. The computer system may include a storage unit 1516. The processor 1502, memory 1504 and the storage unit 1516 communicate via a bus 1508.

In addition, the computer system 1500 can include a static memory 1506, a display driver 1510 (e.g., to drive a plasma display panel (PDP), a liquid crystal display (LCD), or a projector). The computer system 1500 may also include alphanumeric input device 1512 (e.g., a keyboard), a cursor control device 1514 (e.g., a mouse, a trackball, a joystick, a motion sensor, or other pointing instrument), a signal generation device 1518 (e.g., a speaker), and a network interface device 1520, which also are configured to communicate via the bus 1508.

The storage unit 1516 includes a machine-readable medium 1522 on which is stored instructions 1524 (e.g., software) embodying any one or more of the methodologies or functions described herein. The instructions 1524 may also reside, completely or at least partially, within the main memory 1504 or within the processor 1502 (e.g., within a processor's cache memory) during execution thereof by the computer system 1500, the main memory 1504 and the processor 1502 also constituting machine-readable media. The instructions 1524 may be transmitted or received over a network 1526 via the network interface device 1520.

While machine-readable medium 1522 is shown in an example embodiment to be a single medium, the term “machine-readable medium” should be taken to include a single medium or multiple media (e.g., a centralized or distributed database, or associated caches and servers) able to store the instructions 1524. The term “machine-readable medium” shall also be taken to include any medium that is capable of storing instructions 1524 for execution by the machine and that cause the machine to perform any one or more of the methodologies disclosed herein. The term “machine-readable medium” includes, but not be limited to, data repositories in the form of solid-state memories, optical media, and magnetic media.

While machine-readable medium 722 (also referred to as a computer-readable storage medium) is shown in an embodiment to be a single medium, the term “machine-readable medium” should be taken to include a single medium or multiple media (e.g., a centralized or distributed database, or associated caches and servers) able to store the instructions 724. The term “machine-readable medium” shall also be taken to include any medium that is capable of storing instructions 724 for execution by the machine and that cause the machine to perform any one or more of the methodologies disclosed herein. The term “machine-readable medium” shall also be taken to be a non-transitory machine-readable medium. The term “machine-readable medium” includes, but not be limited to, data repositories in the form of solid-state memories, optical media, and magnetic media.

### 12. Additional Considerations

Embodiments of the system and/or method can include every combination and permutation of the various system components and the various method processes.

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. In some cases, a module can be implemented in hardware, firmware, or software.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments. This is done merely for convenience and to give a general sense of the disclosure. This description should be read to include one or at least one and the singular also includes the plural unless it is obvious that it is meant otherwise. Where values are described as “approximate” or “substantially” (or their derivatives), such values should be construed as accurate+/−10% unless another meaning is apparent from the context. From example, “approximately ten” should be understood to mean “in a range from nine to eleven.”

Upon reading this disclosure, those of skill in the art will appreciate still additional alternative structural and functional designs. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed. The scope of protection should be limited only by any claims that issue.

What is claimed is:

1. A mechanical clamp configured to hold an object, the mechanical clamp comprising:
an actuator having an end that is movable;
a base link with a first link end configured to be movably coupled to a link pivot point and with a second link end movably coupled to the end of the actuator, movement of the end of the actuator to cause the second link end to rotate about the link pivot point;
a clamp arm comprising:
a clamp interface configured to interface with a surface of the object to be held;
a first arm coupling element; and
a second arm coupling element mounted to a clamp pivot point, the first arm coupling element and the clamp interface configured to rotate about the clamp pivot point; and
a compressible link with a spring configured to compress along a compression axis, the compressible link coupling the second link end with the first arm coupling element, rotation of the second link end about the link pivot point to cause the compressible link to exert force against the first arm coupling element.

2. The mechanical clamp of claim 1, wherein the second link end rotation about the link pivot point causes the compressible link to exert force against the first arm coupling element in a rotation direction about the clamp pivot point.

3. The mechanical clamp of claim 1, wherein (a) rotation of the second link end about the link pivot point in a first direction and (b) the clamp interface in contact with the object causes the compressible link to compress along the compression axis.

4. The mechanical claim of claim 3, wherein (a) rotation of the second link end about the link pivot point in a second direction different than the first direction and (b) the clamp interface in contact with the object causes the compressible link to decompress along the compression axis.

5. The mechanical clamp of claim 3, wherein (a) rotation of the second link end about the link pivot point in a second direction different than the first direction and (b) the clamp interface in contact with the object causes the first arm coupling element and the clamp interface to rotate about the clamp pivot point.

6. The mechanical clamp of claim 1, wherein (a) rotation of the second link end about the link pivot point and (b) the absence of contact between the clamp interface and the object causes the first arm coupling element and the clamp interface to rotate about the clamp pivot point.

7. The mechanical clamp of claim 1, wherein the second link end rotation about the link pivot point causes an alignment angle between (a) an axis extending between the first link end and the second link end and (b) the compression axis to increase or decrease.

8. The mechanical clamp of claim 1, wherein the base link, the clamp arm, and the compressible link form an over-center mechanism.

9. The mechanical clamp of claim 1, further comprising a second clamp arm comprising:
a second clamp interface configured to interface with a second surface of the object to be held; and
the clamp pivot point.

10. The mechanical clamp of claim 1, wherein the compressible link comprises:
a pivot link coupled to the second link end; and
the spring with a first end coupled to the first arm coupling element and a second end coupled to the pivot link.

11. The mechanical claim of claim 10, wherein the pivot link and the second link end of the base link form a joint.

12. The mechanical clamp of claim 1, wherein the clamp interface includes a clamp bar.

13. The mechanical clamp of claim 1, wherein a clamping force of the mechanical clamp depends on a thickness of the object.

14. The mechanical clamp of claim 13, wherein the clamping force of the mechanical clamp increases with increasing thickness.

15. The mechanical clamp of claim 1, wherein:
the actuator is controlled to move the end between a first position and a second position; and
wherein the mechanical clamp is configured to hold objects of different thicknesses by the actuator moving the end from the first position to the second position.

16. The mechanical clamp of claim 1, wherein:
object has a first thickness, and the mechanical clamp is configured to hold the object by the actuator moving the end from a first position to a second position; and
a second object has a second thickness different that the first thickness, and the mechanical clamp is configured to hold the second object by the actuator moving the end from the first position to the second position.

17. A clamping system comprising:
a set of two or more mechanical clamps, at least one mechanical clamp of the set comprising:
an actuator having an end that is movable;
a base link with a first link end coupled to a link pivot point and a second link end coupled to the end of the actuator, movement of the end of the actuator causing the second link end to rotate about the link pivot point;
a clamp arm comprising:
a clamp interface configured to interface with an object to be held;
a first arm coupling element; and
a second arm coupling element mounted to a clamp pivot point, the first arm coupling element and the clamp interface configured to rotate about the clamp pivot point; and
a compressible link configured to compress along a compression axis, the compressible link coupling the second link end with the first arm coupling element, rotation of the second link end about the link pivot point causing the compressible link to exert force against the first arm coupling element; and
a control system configured to control the set of clamps.

18. The clamping system of claim 17, wherein each of the mechanical clamps in the set include an actuator, a base link, a clamp arm, and a compressible link.

19. The clamping system of claim 18, wherein the set of further comprising a clamp bar shared by the mechanical clamps in the set, wherein each of the clamp arms of the mechanical clamps in the set are configured to rotate toward the clamp bar to hold an object.

20. The clamping system of claim 17, wherein:
the set of clamps are arranged on a rectangular frame; and
the set of clamps includes:
a first subset of clamps arranged on a bottom portion of the rectangular frame;
a second subset of clamps arranged on a top portion of the rectangular frame;
a third subset of clamps arranged on a first vertical portion of the rectangular frame; and
a fourth subset of clamps arranges on a second vertical portion of the rectangular frame, wherein:
the control system is configured to individually control each of the clamps in the first subset and in the second subset;
control of the third subset of clamps is based on control of a first clamp in the first subset or the second subset; and
control of the fourth subset of clamps is based on control of a second clamp in the first subset or the second subset.
